(19) United States
(12) Patent Application Publication
(10) Pub. No.: US 2025/0286118 A1
(43) Pub. Date: Sep. 11, 2025

(54) Anodeless Solid-State Lithium Metal Batteries and Manufacturing Method

(71) Applicant: Honeycomb Battery Company, Dayton, OH (US)

(72) Inventors: Kailash Patil, West Chester, OH (US); Song-Hai Chai, Dayton, OH (US); Hao-Hsun Chang, Centerville, OH (US); Bor Z. Jang, Centerville, OH (US)

(73) Assignee: Honeycomb Battery Company, Dayton, OH (US)

(21) Appl. No.: 18/596,131

(22) Filed: Mar. 5, 2024

(51) Int. Cl. H01M 10/056; H01M 10/0525; H01M 10/42; H01M 50/446

(52) U.S. Cl. CPC H01M 10/056; H01M 10/0525; H01M 10/4235; H01M 50/446; H01M 2300/0085; H01M 2300/0091; H01M 2300/0094

(57) ABSTRACT

A rechargeable lithium metal battery comprising (i) an anode including an anode current collector, but initially no lithium metal or lithium metal alloy deposited on the anode current collector when the battery is made; (ii) a first solid state electrolyte layer deposited on the anode current collector; (iii) a cathode including a cathode current collector and a cathode active layer (including particles of a cathode active material and a conductive additive) deposited on the cathode current collector; (iv) a second solid state electrolyte layer (in physical contact with the first electrolyte layer) disposed on the cathode active layer; and (v) an interface enhancer composition (IEC) in ionic communication with the anode and the cathode. Preferably, the IEC permeates into the cathode active layer and comes in contact with particles of the cathode active material.

The present invention provides a flame-resistant lithium battery (e.g., anodeless lithium metal battery or cell) and method of manufacturing such a battery.

### BACKGROUND

Rechargeable lithium-ion (Li-ion) and lithium metal batteries (e.g., lithium-NCM, lithium-sulfur, lithium selenium, and Li metal-air batteries) are considered promising power sources for electric vehicle (EV), hybrid electric vehicle (HEV), and portable electronic devices, such as lap-top computers and mobile phones. Lithium as a metal element has the highest lithium storage capacity (3,861 mAh/g) compared to any other metal or metal-intercalated compound as an anode active material (except Li_{4.4}Si, which has a specific capacity of 4,200 mAh/g). Hence, in general, Li metal batteries (having a lithium metal anode) have a significantly higher energy density than lithium-ion batteries (having a graphite anode).

However, the liquid electrolytes used for all lithium-ion batteries and lithium metal secondary batteries pose some safety concerns. Most of the organic liquid electrolytes are not resistant to thermal runaway or explosion problems.

Ionic liquids (ILs) are a new class of purely ionic, salt-like materials that are liquid at unusually low temperatures. The official definition of ILs uses the boiling point of water as a point of reference: “Ionic liquids are ionic compounds which are liquid below 100° C.”. A particularly useful and scientifically interesting class of ILs is the room temperature ionic liquid (RTIL), which refers to the salts that are liquid at room temperature or below. RTILs are also referred to as organic liquid salts or organic molten salts. An accepted definition of an RTIL is any salt that has a melting temperature lower than ambient temperature.

Although ILs were suggested as a potential electrolyte for rechargeable lithium batteries due to their non-flammability, conventional ionic liquid compositions have not exhibited satisfactory performance when used as an electrolyte likely due to several inherent drawbacks: (a) ILs have relatively high viscosity at room or lower temperatures; thus being considered as not amenable to lithium ion transport; (b) For Li—S cell uses, ILs are capable of dissolving lithium polysulfides at the cathode and allowing the dissolved species to migrate to the anode (i.e., the shuttle effect remains severe); and (c) For lithium metal secondary cells, most of the ILs strongly react with lithium metal at the anode, continuing to consume Li and deplete the electrolyte itself during repeated charges and discharges. These factors lead to relatively poor specific capacity (particularly under high current or high charge/discharge rate conditions, hence lower power density), low specific energy density, rapid capacity decay and poor cycle life. Consequently, as of today, no commercially available lithium battery makes use of an ionic liquid as the primary electrolyte component.

Solid state electrolytes are commonly believed to be safe in terms of fire and explosion proof. Solid state electrolytes can be divided into organic, inorganic, organic-inorganic composite electrolytes. However, the conductivity of organic polymer solid state electrolytes, such as poly(ethylene oxide) (PEO), polypropylene oxide (PPO), poly(ethylene glycol) (PEG), and poly(acrylonitrile) (PAN), is typically low (<10⁻⁵ S/cm).

Although the inorganic solid-state electrolyte (e.g., garnet-type and metal sulfide-type) can exhibit a high conductivity (about 10⁻⁴ to 10⁻² S/cm), the interfacial impedance or resistance between the inorganic solid-state electrolyte and the electrode (cathode or anode) is high. Further, the traditional inorganic ceramic electrolyte is very brittle and has poor film-forming ability and poor mechanical properties. These materials cannot be cost-effectively manufactured. Although an organic-inorganic composite electrolyte can lead to a reduced interfacial resistance, the lithium ion conductivity and working voltages may be decreased due to the addition of certain organic polymers.

The applicant's research group has previously developed the quasi-solid state electrolytes (QSSE), which may be considered as a fourth type of solid state electrolyte. In certain variants of the quasi-solid state electrolytes, a small amount of liquid electrolyte may be present to help improving the physical and ionic contact between the electrolyte and the electrode, thus reducing the interfacial resistance. Examples of QSSEs are disclosed in the following: Hui He, et al. “Lithium Secondary Batteries Containing a Non-flammable Quasi-solid Electrolyte,” U.S. patent application Ser. No. 13/986,814 (Jun. 10, 2013); U.S. Pat. No. 9,368,831 (Jun. 14, 2016); U.S. Pat. No. 9,601,803 (Mar. 21, 2017); U.S. Pat. No. 9,601,805 (Mar. 21, 2017); U.S. Pat. No. 9,059,481 (Jun. 16, 2015).

However, the presence of an excessive amount of certain types of liquid electrolytes may cause some problems, such as liquid leakage, gassing, and low resistance to high temperature if the cells are not properly handled. Therefore, a novel lithium-ion transport pathway strategy that obviates all or most of these issues is needed.

Hence, a general object of the present invention is to provide a safe, flame/fire-resistant rechargeable lithium cell that does not require a significant modification to the current battery production facilities and processes. Such a lithium cell should also exhibit a high energy density, high power density, low internal resistance, and hast chargeability. Such a novel approach enables the solid-state batteries to have the fastest time to market as compared to other solid-state batteries being developed.

### SUMMARY

The present disclosure provides a rechargeable lithium battery cell comprising (i) an anode including an anode current collector, but initially no lithium metal or lithium metal alloy deposited on the anode current collector when the battery is made; (ii) a first solid state electrolyte layer deposited on the anode current collector; (iii) a cathode including a cathode current collector and a cathode active layer deposited on the cathode current collector; (iv) a second solid state electrolyte layer, the same as or different than the first electrolyte in chemical composition, disposed on the cathode active layer; and (v) an interface enhancer composition in ionic communication with the anode and the cathode, wherein the interface enhancer composition includes a material selected from (i) a lithium salt, (ii) a liquid solution including an organic solvent or ionic liquid, and a lithium salt dissolved or dispersed therein, (iii) a polymer containing a lithium salt dissolved or dispersed therein, or (iv) a combination thereof.

The disclosed battery has at least one of the following features: a) the first solid state electrolyte layer is in physical contact with the second solid state electrolyte layer and the two solid state electrolyte layers, in combination, have a total thickness from 10 nm to 100 μm and are disposed between the anode and the cathode; b) at least one of the two solid state electrolyte layers includes a solid polymer electrolyte, a polymer gel electrolyte, an inorganic solid-state electrolyte, or a polymer/inorganic composite electrolyte, wherein at least one of the first and the second solid state electrolyte layer has a lithium-ion conductivity no less than 10⁻⁶ S/cm, preferably from 10⁻⁵ to 3.5×10⁻² S/cm; c) at least one of the two solid state electrolyte layers includes a solid polymer electrolyte or a polymer gel electrolyte including an elastomer having a thickness from 50 nm to 100 μm and a lithium ion conductivity from 10⁻⁶ S/cm to 5×10⁻² S/cm at room temperature and a fully recoverable tensile strain from 2% to 1,000% when measured without any additive dispersed therein; and d) the cathode active layer includes particles of a Li-containing cathode active material, from 0.01% to 10% by weight of a conductive additive (preferably from 0.1% to 5%), optionally from 0.1% to 20% by weight of the second solid state electrolyte, and pores occupying 1% to 40% by volume of the cathode active layer, wherein the interface enhancer composition resides in 30% to 100% of the pores.

Such a lithium metal battery may be referred to as an “anodeless lithium metal battery” since the anode initially does not contain any anode active material (i.e., no lithium metal or lithium alloy) when the battery is produced. The anode receives lithium from the cathode side when the battery is subsequently charged. The battery cell may be a cylindrical cell, a pouch cell, or a prismatic cell.

In some embodiments, the interface enhancer composition, the cathode active layer, the first solid state electrolyte, and/or the second solid state electrolyte further includes a flame retardant additive. The flame retardant additive, as examples, may be selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

In some preferred embodiments, the interface enhancer composition forms a contiguous phase or a continuous lithium ion pathway from the cathode active material through the first and the second solid-state electrolyte layers to the anode and the interface enhancer composition is in physical contact with substantially all particles of the cathode active material.

In some embodiments, the interface enhancer composition includes (i) a lithium salt or (ii) a liquid solution including an ionic liquid or an organic solvent and a lithium salt dissolved or dispersed in the ionic liquid or organic solvent, and wherein the interface enhancer composition forms a contiguous phase or a continuous lithium ion pathway from the cathode active material through the solid state electrolyte layers to the anode.

The first solid state electrolyte layer and the second solid state electrolyte layer can be two separate and discrete layers. However, the two can be merged and integrated into one single layer when the anode side and the cathode side are combined and laminated together. Either one or both layers are essentially a separator layer that electronically separates the anode from the cathode. The solid-state electrolyte layer can have pores to accommodate the interface enhancer composition or can be pore-free provided that it has a lithium-ion conductivity greater than 10⁻⁶ S/cm (preferably from 10⁻⁵ S/cm to 3.5×10⁻² S/cm or higher).

In some embodiments, the anode includes initially an anode current collector only (i.e. a so-called “anode-less lithium cell”) or includes a lithium metal or lithium alloy layer supported on an anode current collector (e.g., a lithium metal cell).

In some preferred embodiments, the interface enhancer composition, either or both solid-state electrolyte layers, and/or the cathode active layer further include a flame retardant additive. The flame retardant additive may be selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

In a highly desirable embodiment, the interface enhancer composition includes a lithium salt or a liquid solution including an ionic liquid (or an organic solvent) and a lithium salt dissolved or dispersed therein, and wherein the interface enhancer composition forms a contiguous phase or a continuous lithium ion pathway from the cathode active material through the solid-state electrolyte layer(s) to the anode.

In some embodiments, the ionic liquid in the interface enhancer composition is selected from a room temperature ionic liquid having a cation selected from tetraalkylammonium, di-, tri-, or tetra-alkylimidazolium, alkylpyridinium, dialkyl-pyrrolidinium, dialkylpiperidinium, tetraalkylphosphonium, trialkylsulfonium, 1-butyl-3-methylimidazolium hexafluorophosphate (bmimPF₆), 1-butyl-3-methylimidazolium acetate (bmimACET), 1-butyl-3-methylimidazolium thiocyanate (bmimSCN), EMITFSI, [Cₙmim][TFSI] or [Cₙmim][FSI] (n=2, 4), 1-ethyl-3-methylimidazolium bis(fluorosulfonyl)imide ([C2mim][FSI]), N-methyl-N-propylpyrrolidinium bis(fluorosulfonyl)imide ([Pry13][FSI]), 1-Ethyl-3-methylimidazolium bis(trifluoromethylsulfonyl)imide ([EMIM][TFSI]), 1-Ethyl-3-methylimidazolium trifluoromethanesulfonate ([EMIM][Tf]) and 1-Butyl-3-methylimidazolium dicyanamide ([BMIM][DCA]), or a combination thereof.

The ionic liquid in the interface enhancer composition may be selected from a room temperature ionic liquid having an anion selected from BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, a thiocyanate anion, or a combination thereof.

In certain embodiments, the organic solvent in the interface enhancer composition is selected from a fluorinated carbonate, hydrofluoroether, fluorinated ester, fluorinated vinyl carbonate, fluorinated ether, fluorinated vinyl ester, and fluorinated vinyl ether, sulfone, nitrile, phosphate, phosphite, alkyl phosphonate, phosphazene, sulfate, siloxane, silane, 1,3-dioxolane (DOL), 1,2-dimethoxyethane (DME), tetraethylene glycol dimethylether (TEGDME), poly(ethylene glycol)dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma.-butyrolactone (γ-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a fluorinated solvent, a sulfone, a sulfide, a nitrile, a phosphate, a phosphite, a phosphonate, a phosphazene, a sulfate, a siloxane, Glyme, a chemical derivative thereof, or a combination thereof. Preferably, the liquid or the polymer in the interface enhancer composition includes a lithium salt of 0.1%-50% by weight dispersed therein.

Most of these liquids are polymerizable or cross-linkable; e.g., those organic compounds containing unsaturated C═C bonds, cyclic carbonates, cyclic esters, cyclic ethers, and combinations thereof. In the lithium-ion battery or lithium metal battery industry, the liquid solvents listed above are commonly used as a solvent to dissolve a lithium salt therein and the resulting solutions are used as a liquid electrolyte. It is uniquely advantageous to be able to polymerize the liquid solvent once injected into an anode, a cathode, a solid-state electrolyte, or a battery cell, enabling the formation of a contiguous lithium salt-containing solid polymer phase. With such a novel strategy, one can readily reduce the liquid solvent or completely eliminate the liquid solvent all together. This is of significant utility value since most of the organic solvents are known to be volatile and flammable, posing a fire and explosion danger.

Desirable liquid solvents include fluorinated monomers having unsaturation (double bonds or triple bonds that can be opened up for polymerization); e.g., fluorinated vinyl carbonates, fluorinated vinyl monomers, fluorinated esters, fluorinated vinyl esters, and fluorinated vinyl ethers). Fluorinated vinyl esters include R_{f}CO₂CH═CH₂ and Propenyl Ketones, R_{f}COCH═CHCH₃, where R_{f} is For any F-containing functional group (e.g., CF₂— and CF₂CF₃—).

Two examples of fluorinated vinyl carbonates are given below:

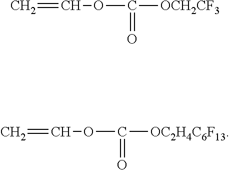

These liquid solvents, as a monomer, can be cured in the presence of an initiator (e.g., 2-Hydroxy-2-methyl-1-phenyl-propan-1-one, Ciba DAROCUR-1173, which can be activated by UV or electron beam):

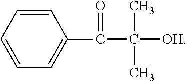

In some embodiments, the fluorinated carbonate is selected from vinyl- or double bond-containing variants of fluoroethylene carbonate (FEC), DFDMEC, FNPEC, a combination thereof, or a combination thereof with hydrofluoro ether (HFE), trifluoro propylene carbonate (FPC), or methyl nonafluorobutyl ether (MFE), wherein the chemical formulae for FEC, DFDMEC, and FNPEC, respectively are shown below:

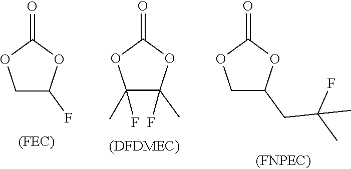

Desirable sulfones as a polymerizable liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone:

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R═NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt₂, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

Poly(sulfone)s have high oxygen indices and low smoke emission on burning. Poly(sulfone)s are inherently self-extinguishing materials owing to their highly aromatic character. A hydroxy-terminated copoly(ester sulfone) synthesized by melt polycondensation of the diethylene glycol and 4,4-dihydroxydiethoxydiphenyl sulfone with adipic acid can be used as a flame retardant.

In certain embodiments, the sulfone is selected from TrMS, MTrMS, TMS, or vinyl or double bond-containing variants of TrMS, MTrMS, TMS, EMS, MMES, EMES, EMEES, or a combination thereof; their chemical formulae being given below:

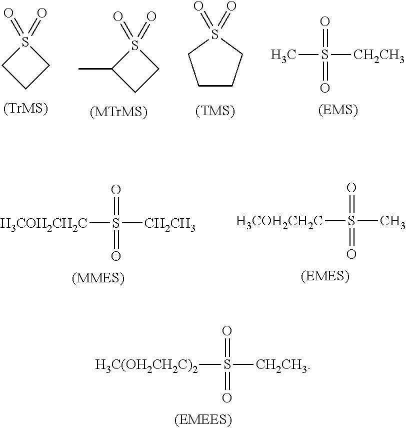

The cyclic structure, such as TrMS, MTrMS, and TMS, can be polymerized via ring-opening polymerization with the assistance of an ionic type initiator.

The nitrile may be selected from dinitriles, such as AND, GLN, SEN and SN, which have the following chemical formulae:

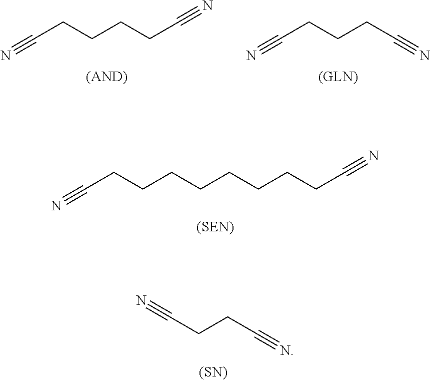

In some embodiments, the phosphate, phosphonate, phosphazene, phosphite, or sulfate is selected from tris(trimethylsilyl)phosphite (TTSPi), alkyl phosphate, triallyl phosphate (TAP), ethylene sulfate (DTD), a combination thereof. The phosphate, alkyl phosphonate, or phosphazene may be selected from the following:

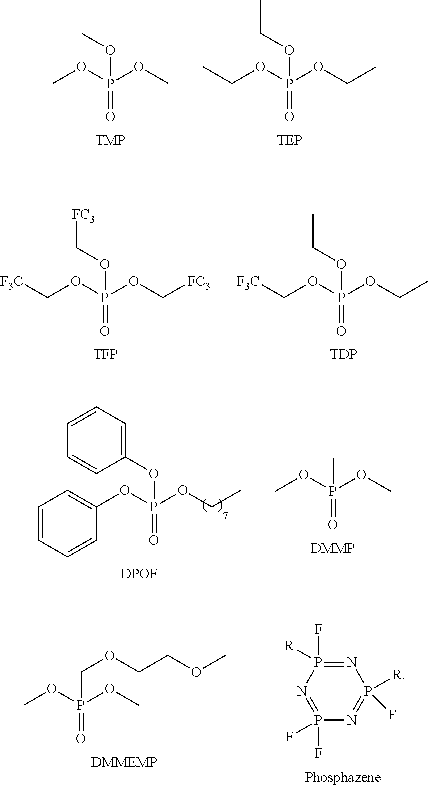

The phosphate, alkyl phosphonate, phosphonic acid, and phosphazene, upon polymerization, are found to be essentially non-flammable. Good examples include diethyl vinylphosphonate, dimethyl vinylphosphonate, vinylphosphonic acid, diethyl allyl phosphate, and diethyl allylphosphonate:

Examples of a polymerizable phosphazene contain derivatives with a general structural formula:

[—NP(A)ₐ(B)_{b}—]ₓ

wherein the groups A and B are bonded to phosphorus atoms through —O—, —S—, —NH—, or —NR— (with R═C₁-C₆)alkyl), and wherein A stands more precisely for a vinyl ether group or a styrene ether group, and B stands more precisely for a hydrocarbon group. In general, A contains at least one vinyl ether group of the general formula Q-O—CR′═CHR″ and/or styrene ether group of the general formula:

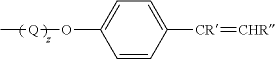

wherein R′ and/or R″ stands for hydrogen or C₁-C₁₀ alkyl; B stands for a reactive or nonreactive hydrocarbon group optionally containing O, S, and/or N. and optionally containing at least one reactive group; Q is an aliphatic, cycloaliphatic, aromatic, and/or heterocyclic hydrocarbon group, optionally containing O, S, and/or N; a is a number greater than 0; b is 0 or a number greater than 0 and a+b=2; x stands for a whole number that is at least 2; and z stands for 0 or 1. Initiators for these phosphazene derivatives can be those of Lewis acids, SbCl₃, AlCl₃, or sulfur compounds.

The siloxane or silane may be selected from alkylsiloxane (Si—O), alkyylsilane (Si—C), liquid oligomeric silaxane (—Si—O—Si—), or a combination thereof.

In the disclosed lithium battery, the lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

In certain desirable embodiments, the inorganic solid-state electrolyte or the polymer/inorganic composite electrolyte includes an inorganic solid electrolyte material selected from an oxide type, sulfide type, hydride type, halide type, halogen-modified sulfide type, borate type, phosphate type, lithium phosphorus oxynitride (LiPON), garnet-type, lithium superionic conductor (LISICON) type, sodium superionic conductor (NASICON) type, or a combination thereof.

In some embodiments, the polymer/inorganic composite electrolyte includes particles of inorganic material selected from SiO₂, TiO₂, Al₂O₃, MgO₂, ZnO₂, ZnO₂, CuO, CdO, Li₂CO₃, Li₂O, Li₂C₂O₄, LiOH, LIX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

The solid-state electrolyte may include a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentacrythritol tetra-acrylate-based polymer, an aliphatic polycarbonate, a single Li-ion conducting solid polymer (e.g., those with a carboxylate anion, a sulfonylimide anion, or sulfonate anion), poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), an acrylic polymer, a butyl acrylate rubber, polyphosphate, polyphosphitc, polyphosphonate, polyphosphazenes, polytetrahydrofuran, a copolymer thereof, a semi-penetrating network thereof, a sulfonated derivative thereof, or a combination thereof.

In certain embodiments, the first or second solid-state electrolyte includes an elastomer selected from natural polyisoprene, synthetic polyisoprene, polybutadiene, chloroprene rubber, polychloroprene, butyl rubber, poly(butyl diacrylate), styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof.

The elastomer may contain a lightly cross-linked network of polymer chains having an ether linkage, nitrile-derived linkage, benzo peroxide-derived linkage, ethylene oxide or ethylene glycol linkage, propylene oxide linkage, vinyl alcohol linkage, cyano-resin linkage, triacrylate monomer-derived linkage, tetraacrylate monomer-derived linkage, a derivative thereof, or a combination thereof, in the cross-linked network of polymer chains having a degree of crosslinking that affords an elasticity of the polymer in the range from 5% to 1,000%.

The elastomer may further include from 0.1% to 70% by weight of a lithium ion-conducting material dispersed or dissolved in the high-elasticity polymer. The lithium ion-conducting material includes a lithium salt selected from lithium perchlorate, LiClO₄, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid-based lithium salt, Li₂CO₃, Li₂O, Li₂C₂O₄, LiOH, LIX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

In some embodiments, the elastomer includes from 5% to 95% by weight of a lithium ion-conducting plastic crystal or organic domain phase dispersed in or connected to the elastomer.

The present disclosure further provides a rechargeable lithium battery, including a lithium metal secondary cell, a lithium-sulfur cell, or a lithium-selenium cell. This battery features a non-flammable, safe, and high-performing electrolyte as herein disclosed.

For a lithium metal cell (where lithium metal is the primary active anode material), the anode current collector may include a foil, perforated sheet, or foam of a metal having two primary surfaces wherein at least one primary surface is coated with or protected by a layer of lithiophilic metal (a metal capable of forming a metal-Li solid solution or is wettable by lithium ions), a layer of graphene material, or both. The metal foil, perforated sheet, or foam is preferably selected from Cu, Ni, stainless steel, Al, graphene-coated metal, graphite-coated metal, carbon-coated metal, or a combination thereof. The lithiophilic metal is preferably selected from Au, Ag, Mg, Zn, Ti, K, Al, Fe, Mn, Co, Ni, Sn, V, Cr, an alloy thereof, or a combination thereof.

There is no limitation on what type of cathode active materials that can be used to practice the present disclosure. As some non-limiting examples, the cathode may include a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), lithium nickel manganese oxide (LiNi_{q}Mn_{2-q}O₄, 0<q<2), lithium polysulfide, lithium polyselenide, or a combination thereof.

The rechargeable lithium cell may further include a cathode current collector selected from aluminum foil, carbon- or graphene-coated aluminum foil, stainless steel foil or web, carbon- or graphene-coated steel foil or web, carbon or graphite paper, carbon or graphite fiber fabric, flexible graphite foil, graphene paper or film, or a combination thereof. A web means a screen-like structure or a metal foam, preferably having interconnected pores or through-thickness apertures.

The present disclosure also provides a method of producing the disclosed rechargeable lithium cell, the method comprising: (a) preparing an anode including an anode current collector and a first solid state electrolyte layer deposited on a primary surface of the anode current collector; (b) preparing a cathode including a cathode active layer supported on a cathode current collector and a second solid state electrolyte layer deposited on the cathode active layer, wherein the cathode active layer includes particles of a cathode active material, from 0.1% to 10% by weight of a conductive additive, optionally from 0.1% to 20% by weight of the second solid state electrolyte, and pores occupying from 1% to 40% by volume of the cathode active layer; (c) introducing or depositing an interface enhancer composition into the pores of the cathode active layer, onto or into the first solid state electrolyte layer, and/or onto or into the second solid state electrolyte layer; and (d) combining (e.g., stacking, laminating, etc.) the anode and the cathode together, with the first solid state electrolyte layer facing the second solid state electrolyte layer, and a protective housing to form the lithium cell. Compressing of the cell may be conducted by using roll-pressing, hot/cold press compression, etc.

In certain embodiments, the method further includes a Step (c) of conducting electrochemical formation of the cell by charging and discharging the cell at least one cycle, optionally removing formation-induced gaseous species from the cell, sealing the cell, and/or compressing the cell to produce the rechargeable lithium cell.

In certain embodiments, Step (c) of introducing or depositing the interface enhancer composition includes at least one of the following procedures: (i) preparing a liquid solution including an organic solvent and a lithium salt dissolved therein and (A) impregnating the liquid solution into pores of the cathode, allowing the liquid solution to permeate into the pores or (B) depositing the liquid solution onto a surface of the first or second solid state electrolyte layer, allowing the liquid solution to permeate into either or both solid state electrolyte layers, and then partially or completely removing the organic solvent, leaving behind lithium salt precipitated out in the pores or staying in either or both of solid state electrolyte layers; (ii) preparing an ionic liquid solution including an ionic liquid and a lithium salt dissolved therein and impregnating the ionic liquid solution into the cathode, the first solid state electrolyte, and/or the second solid state electrolyte; (iii) preparing a polymer solution including an organic solvent, a polymer and a lithium salt dissolved in the organic solvent and impregnating the polymer solution into pores of the cathode, allowing the polymer solution to permeate into the pores and then partially or completely removing the organic solvent, leaving behind lithium salt and the polymer precipitated out in the pores, wherein the lithium salt is dispersed in the polymer; and (iv) preparing a reactive polymer precursor solution including a monomer, an oligomer, an initiator and/or a cross-linking agent, and a lithium salt dissolved in the precursor solution, and impregnating the reactive polymer precursor into pores of the cathode, allowing the polymer solution to permeate into the pores and polymerizing and/or crosslinking the precursor solution. The procedure of polymerizing and/or crosslinking may include exposing the reactive polymer precursor to heat, ultraviolet light, high-energy radiation, or a combination thereof.

In certain embodiments, Step (c) includes preloading the first and/or second solid-state electrolyte layers with the interface enhancer composition.

In some embodiments, the cathode active layer further includes 0.1% to 30% by weight of particles of an inorganic solid electrolyte powder in the cathode.

To prepare a cathode as in step (b), an active material (e.g. cathode active material particles, such as NCM, NCA and lithium iron phosphate), a conducting additive (e.g. carbon black, carbon nanotubes, expanded graphite flakes, or graphene sheets), an optional flame-retardant agent, optional solid state electrolyte (e.g., 0.1-30% by weight of a polymer), and/or optional particles of an inorganic solid electrolyte may be dissolved/dispersed in a liquid solvent (e.g., NMP) and mixed to form a slurry or paste. The slurry or paste is then made into a desired electrode shape (e.g. cathode electrode), possibly supported on a surface of a current collector (e.g. an Al foil as a cathode current collector). The resulting cathode layer typically has a porosity level of up to 40% by volume, but can be higher or lower.

The interface enhancer composition may be introduced into the pores of the cathode active layer via spraying, coating casting, printing, painting the interface enhancer onto a surface of the cathode layer, 1^{st} solid-state electrolyte layer, and/or 2^{nd} solid-state electrolyte layer, or by dipping the cathode layer and/or the solid-state electrolyte layers into the interface enhancer composition while in a liquid state.

In some embodiments, this procedure of introducing into pores of a cathode layer, into pores of the first solid state electrolyte layer (or onto a surface of this layer), and/or the second solid-state electrolyte layer (or onto a surface of this layer) may be accomplished by at least one of the following procedures:
(a1) impregnating a liquid solution of an organic solvent and a lithium salt dissolved therein into pores of the cathode or into/onto a first or second solid state electrolyte layer (e.g., by spraying, coating, or printing the liquid solution onto the cathode active layer surface or immersing the cathode active layer in the liquid solution), allowing the liquid solution to permeate into pores and then partially or completely removing the organic solvent, leaving behind lithium salt precipitated out in the pores;
(a2) impregnating a liquid solution of an ionic liquid and a lithium salt dissolved therein into pores of the cathode or into/onto a first or second solid state electrolyte layer (e.g., by spraying, coating, or printing the liquid solution onto the cathode active layer surface or immersing the cathode active layer in the liquid solution), allowing the liquid solution to permeate into pores;
(a3) impregnating a polymer solution, including an organic solvent, a polymer and a lithium salt dissolved in the organic solvent, into pores of the cathode or into/onto a first or second solid state electrolyte layer (e.g., by spraying, coating, or printing the polymer solution onto the cathode active layer surface or immersing the cathode active layer in the liquid solution), allowing the polymer solution to permeate into pores and then partially or completely removing the organic solvent, leaving behind lithium salt and the polymer precipitated out in the pores, wherein the lithium salt is dispersed in the polymer; and
(a4) impregnating a reactive polymer precursor solution, including a monomer, an oligomer, an initiator and/or a cross-linking agent, and a lithium salt dissolved in the precursor solution, into pores of the cathode or into/onto a first or second solid state electrolyte layer (e.g., by spraying, coating, or printing the polymer solution onto the cathode active layer surface or immersing the cathode active layer in the liquid solution), allowing the polymer solution to permeate into pores and then polymerizing and/or crosslinking the precursor solution.

The interface enhancer composition is designed to permeate into the internal structure of the cathode and to be in physical contact or ionic contact with substantially all particles of the cathode active material in the cathode, and to permeate into/onto a first or second solid state electrolyte layer. A compression or pressure can help the permeation of the interface enhancer composition (when still containing some liquid ingredient) into pores and making contact with all cathode active materials.

In some embodiments, the layer of solid-state electrolyte in step (b) is preloaded (e.g., pre-impregnated or pre-coated) with an interface enhancer composition. This preloading procedure may be conducted by a procedure analogous to one of the aforementioned (a1), (a2), (a3), and (a4).

The anode electrode, a cathode electrode, and the enhancer-preloaded solid-state electrolyte layer(s), along with a protective housing, are then combined to form a battery cell.

In some embodiments, step (d) further includes an electrochemical formation procedure, a gas removal procedure, a cell compression procedure, or a combination thereof.

In some embodiments, the interface enhancer composition includes a polymerizable or cross-linkable liquid containing a lithium salt dissolved therein, and the method further includes polymerizing or cross-linking this liquid in the anode, the solid-state electrolyte, or the cathode before, during, or after step C).

The polymerizable or cross-linkable liquid may be selected from acrylate, allyl, and vinyl ether monomers or oligomers, vinyl ethylene carbonate (VEC), vinylene carbonate (VC), acrylate or methyl acrylate, fluorinated vinyl carbonates, vinyl containing phosphates, phosphonate or phosphonic acid (e.g., diethyl allylphosphonate diethyl vinylphosphonate, dimethyl vinylphosphonate, etc.), vinyl acetate, unsaturated phosphazene, vinyl containing ionic liquid (such as 1-vinyl-3-dodecylimidazolium bis(trifluoromethanesulfonyl)imide), functional vinyl sulfide, sulfoxide, or sulfone, Alkyl(meth)acrylate, N,N-dialkylacrylamide, vinyl alkyl ketone, meth(acrylo)nitrile, ethylene oxide, propylene sulfide, alpha-cyanoacrylate, vinylidene cyanide, ¿-caprolactone, and ¿-caprolactam, vinyl ether and its derivatives, a-methyl vinyl ether, 1,3-dioxolane (DOL), tetrahydrofuran (THF), trioxymethylene, oxazoline, oxetan-2-one, oxirane and thietane, trimethylene carbonate (TMC), Glyme, organic compounds with epoxy group, —NH₂ group or SH group, or a combination thereof

The procedure of polymerizing and/or crosslinking may include exposing the reactive additive to heat, UV, high-energy radiation, or a combination thereof. The high-energy radiation may be selected from electron beam, Gamma radiation, X-ray, neutron radiation, etc. Electron beam irradiation is particularly useful.

These and other advantages and features of the present invention will become more transparent with the description of the following best mode practice and illustrative examples.

### BRIEF DESCRIPTION OF THE DRAWINGS

FIG. 1 A process flow chart to illustrate a method of producing a lithium metal battery including two substantially solid-state electrolyte layers according to some embodiments of the present disclosure.

FIG. 2(A) Structure of an anode-less lithium metal cell (as manufactured or in a discharged state) according to some embodiments of the present disclosure;

FIG. 2(B) Structure of an anode-less lithium metal cell (in a charged state) according to some embodiments of the present disclosure.

FIG. 3 Schematic of a process for producing an anodeless lithium metal battery including two substantially solid-state electrolyte layers according to some embodiments of the present disclosure.

### DETAILED DESCRIPTION

The present disclosure provides a safe and high-performing lithium battery, which can be any of various types of lithium metal cells. A high degree of safety is imparted to this battery by novel and unique electrolytes that are highly flame-resistant and would not initiate a fire or sustain a fire and, hence, would not pose explosion danger. This disclosure has solved the very most critical issue that has plagued the lithium-metal industries for more than three decades. This disclosure also solves the large interfacial and internal impedance problem of all the solid-state batteries.

As indicated earlier in the Background section, a strong need exists for a safe, non-flammable rechargeable lithium cell that is compatible with existing battery production facilities. It is well-known in the art that solid-state electrolyte battery typically cannot be produced using existing lithium-ion battery production equipment or processes.

The present disclosure provides a rechargeable lithium battery including (i) an anode including an anode current collector, but initially no lithium metal or lithium metal alloy deposited on the anode current collector when the battery is made; (ii) a first solid state electrolyte layer deposited on the anode current collector; (iii) a cathode including a cathode current collector and a cathode active layer deposited on the cathode current collector; (iv) a second solid state electrolyte layer, the same as or different than the first electrolyte in chemical composition, disposed on the cathode active layer; and (v) an interface enhancer composition in ionic communication with the anode and the cathode; wherein the battery has at least one of the following features:
a) the first solid state electrolyte layer is in physical contact with the second solid state electrolyte layer and the two solid state electrolyte layers, in combination, have a total thickness from 10 nm to 100 μm and are disposed between the anode and the cathode;
b) at least one of the two solid state electrolyte layers includes a solid polymer electrolyte, a polymer gel electrolyte, an inorganic solid-state electrolyte, or a polymer/inorganic composite electrolyte, wherein at least one of the first and the second solid state electrolyte layer has a lithium-ion conductivity no less than 10⁻⁶ S/cm, preferably from 10⁻⁵ to 3.5×10⁻² S/cm;
c) the interface enhancer composition includes a material selected from (i) a lithium salt, (ii) a liquid solution including an organic solvent or ionic liquid, and a lithium salt dissolved or dispersed therein, (iii) a polymer containing a lithium salt dissolved or dispersed therein, or (iv) a combination thereof; and
d) the cathode active layer includes particles of a Li-containing cathode active material, from 0.01% to 10% by weight of a conductive additive (preferably from 0.1% to 5%), optionally from 0.1% to 20% by weight of the second solid state electrolyte, and pores occupying 1% to 40% by volume of the cathode active layer, wherein the interface enhancer composition resides in 30% to 100% of the pores.

The disclosed lithium battery can be any lithium metal battery having lithium metal as the primary anode active material. In general, the lithium metal battery can have lithium metal implemented at the anode when the cell is made. However, in the present disclosure, the lithium may be stored in the cathode active material and the anode side is lithium metal-free initially. This is called an anode-less lithium metal battery.

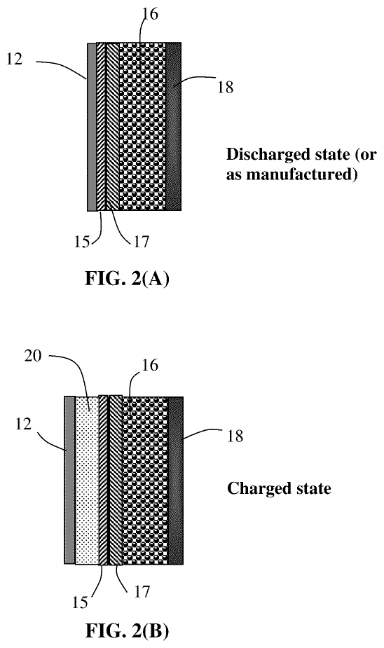

As illustrated in FIG. 2(A), the anode-less lithium cell is in an as-manufactured or fully discharged state according to certain embodiments of the present disclosure. The cell includes an anode current collector 12 (e.g., Cu foil), the first solid-state electrolyte layer 15, the second solid state electrolyte layer 17, a cathode active layer 16 including a cathode active material, an optional conductive additive (not shown), an optional solid state electrolyte (not shown), and an interface enhancer composition (residing in the pores of the entire cathode layer and in contact with the cathode active material), and a cathode current collector 18 that supports the cathode active layer 16. There is no lithium metal in the anode side when the cell is manufactured. However, preferably there is a thin layer of interface enhancer composition being present between the anode current collector and the first solid-state electrolyte layer.

In a charged state, as illustrated in FIG. 2(B), the cell includes an anode current collector 12, lithium metal 20 plated on a surface (or two surfaces) of the anode current collector 12 (e.g., Cu foil), the first solid-state electrolyte layer 15, the second solid state electrolyte layer 17, a cathode active layer 16, and a cathode current collector 18 supporting the cathode layer. The lithium metal comes from the cathode active material (e.g., LiCoO₂ and LiMn₂O₄) that contains Li element when the cathode is made. During a charging step, lithium ions are released from the cathode active material and move to the anode side to deposit onto a surface or both surfaces of an anode current collector. There is preferably a thin layer of interface enhancer composition being present between the lithium metal layer and the solid-state electrolyte layer.

In some embodiments, the interface enhancer composition includes (i) a lithium salt or (ii) a liquid solution including an ionic liquid or an organic solvent and a lithium salt dissolved or dispersed in the ionic liquid or organic solvent, and wherein the interface enhancer composition forms a contiguous phase or a continuous lithium ion pathway from the cathode active material through the solid state electrolyte layers to the anode.

The first solid state electrolyte layer and the second solid state electrolyte layer can be two separate and discrete layers. However, the two can be merged and integrated into one single layer when the anode side and the cathode side are combined and laminated together. Either one or both layers are essentially a separator layer that electronically separates the anode from the cathode. The solid-state electrolyte layer can have pores to accommodate the interface enhancer composition or can be pore-free provided that it has a lithium-ion conductivity greater than 10⁻⁶ S/cm (preferably from 10⁻⁵ S/cm to 3.5×10⁻² S/cm or higher).

The interface enhancer composition is preferably selected from those having a higher resistance to electrochemical oxidation (preferably stable above 4.2 V relative to Li/Li⁺, further preferably stable above 4.5 V). The interface enhancer composition is further preferably selected from those having a higher resistance to electrochemical reduction (preferably stable below 1.0 V, further preferably stable below 0.5 V, and most preferably below 0.2 V relative to Li/Li⁺). In the disclosed polymer electrolyte, the lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The disclosed battery can function well with or without an additional polymer separator; e.g., porous polyethylene (PE), polypropylene (PP), PE/PP copolymer membrane, etc. The solid-state electrolyte layers disposed between the anode current collector and the cathode active layer serve effectively as a separator that electronically isolates the anode from the cathode. The solid-state electrolytes can have pores to accommodate the interface enhancer composition or can be pore-free provided that it has a lithium-ion conductivity greater than 10⁻⁶ S/cm (preferably from 10⁻⁵ S/cm to 3.5×10⁻² S/cm).

In certain embodiments, the first or second solid-state electrolyte includes an elastomer selected from natural polyisoprene, synthetic polyisoprene, polybutadiene, chloroprene rubber, polychloroprene, butyl rubber, poly(butyl diacrylate), styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof.

The elastomer may contain a lightly cross-linked network of polymer chains having an ether linkage, nitrile-derived linkage, benzo peroxide-derived linkage, ethylene oxide or ethylene glycol linkage, propylene oxide linkage, vinyl alcohol linkage, cyano-resin linkage, triacrylate monomer-derived linkage, tetraacrylate monomer-derived linkage, a derivative thereof, or a combination thereof, in the cross-linked network of polymer chains having a degree of crosslinking that affords an elasticity of the polymer in the range from 5% to 1,000%. The elastomer may further include from 0.1% to 70% by weight of a lithium ion-conducting material dispersed or dissolved in the high-elasticity polymer. The lithium ion-conducting material includes a lithium salt selected from lithium perchlorate, LiClO₄, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LIN (CF₃SO₂) 2), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid-based lithium salt, Li₂CO₃, Li₂O, Li₂C₂O₄, LiOH, LIX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

In some embodiments, the elastomer includes from 5% to 95% by weight of a lithium ion-conducting plastic crystal or organic domain phase dispersed in or connected to the elastomer.

The anode includes initially an anode current collector only (i.e., a so-called “anode-less lithium cell”) or includes a lithium metal or lithium alloy layer supported on an anode current collector (e.g., a lithium metal cell). It may be noted that if no conventional anode active material, such as graphite, Si, SiO, Sn, and conversion-type anode materials, and no lithium metal is present in the cell when the cell is made and before the cell begins to charge and discharge, the battery cell is commonly referred to as an “anode-less” lithium cell.)

The presently disclosed battery features electrolytes that are substantially solid-state electrolyte having the following highly desirable and advantageous features: (i) good solid electrolyte-electrode contact and interfacial stability (minimal solid electrode-electrolyte interfacial impedance) similar to what is commonly enjoyed by a liquid electrolyte; (ii) good processibility and ease of battery cell production; (iii) highly resistant to flame and fire.

In some preferred embodiments, the interface enhancer composition or the solid-state electrolyte layers further include a flame retardant additive. The flame retardant additive may be selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

Flame-retardant additives are intended to inhibit or stop polymer pyrolysis and combustion processes by interfering with the various mechanisms involved-heating, ignition, and propagation of thermal degradation.

There is no limitation on the type of flame retardant that can be physically or chemically incorporated into the elastic polymer. The main families of flame retardants are based on compounds containing: Halogens (Bromine and Chlorine), Phosphorus, Nitrogen, Intumescent Systems, Minerals (based on aluminum and magnesium), and others (e.g. Borax, Sb₂O₃, and nanocomposites). Antimony trioxide is a good choice, but other forms of antimony such as the pentoxide and sodium antimonate may also be used.

One may use the reactive types (being chemically bonded to or becoming part of the polymer structure) and additive types (simply dispersed in the polymer matrix). For instance, reactive polysiloxane can chemically react with EPDM type elastic polymer and become part of the crosslinked network polymer. It may be noted that flame-retarding group modified polysiloxane itself is an elastic polymer composite containing a flame retardant according to an embodiment of instant disclosure. Both reactive and additive types of flame retardants can be further separated into several different classes:
1) Minerals: Examples include aluminum hydroxide (ATH), magnesium hydroxide (MDH), huntite and hydromagnesite, various hydrates, red phosphorus and boron compounds (e.g. borates).
2) Organo-halogen compounds: This class includes organochlorines such as chlorendic acid derivatives and chlorinated paraffins; organobromines such as decabromodiphenyl ether (decaBDE), decabromodiphenyl ethane (a replacement for decaBDE), polymeric brominated compounds such as brominated polystyrenes, brominated carbonate oligomers (BCOs), brominated epoxy oligomers (BEOs), tetrabromophthalic anyhydride, tetrabromobisphenol A (TBBPA), and hexabromocyclododecane (HBCD).
3) Organophosphorus compounds: This class includes organophosphates such as triphenyl phosphate (TPP), resorcinol bis(diphenylphosphate) (RDP), bisphenol A diphenyl phosphate (BADP), and tricresyl phosphate (TCP); phosphonates such as dimethyl methylphosphonate (DMMP); and phosphinates such as aluminum diethyl phosphinate. In one important class of flame retardants, compounds contain both phosphorus and a halogen. Such compounds include tris(2,3-dibromopropyl) phosphate (brominated tris) and chlorinated organophosphates such as tris(1,3-dichloro-2-propyl) phosphate (chlorinated tris or TDCPP) and tetrakis(2-chlorethyl) dichloroisopentyldiphosphate (V6).
4) Organic compounds such as carboxylic acid and dicarboxylic acid

The mineral flame retardants mainly act as additive flame retardants and do not become chemically attached to the surrounding system (the polymer). Most of the organo-halogen and organophosphate compounds also do not react permanently to attach themselves into the polymer. Certain new non halogenated products, with reactive and non-emissive characteristics have been commercially available as well.

In certain embodiments, the flame retardant additive is in a form of encapsulated particles including the additive encapsulated by a shell of coating material that is breakable or meltable when exposed to a temperature higher than a threshold temperature (e.g., flame or fire temperature induced by internal shorting). The encapsulating material is a substantially lithium ion-impermeable and liquid electrolyte-impermeable coating material. The encapsulating or micro-droplet formation processes that can be used to produce protected flame-retardant particles are well-known in the art of medicine capsules (e.g., spray-drying).

In a highly desirable embodiment, the interface enhancer composition includes a lithium salt or a liquid solution including an ionic liquid or an organic solvent, and a lithium salt dissolved or dispersed therein, and wherein the interface enhancer composition forms a contiguous phase or a continuous lithium ion pathway from the cathode active material through the solid-state electrolyte layers to the anode.

In some embodiments, the ionic liquid in the interface enhancer composition is selected from a room temperature ionic liquid having a cation preferably selected from tetraalkylammonium, di-, tri-, or tetra-alkylimidazolium, alkylpyridinium, dialkyl-pyrrolidinium, dialkylpiperidinium, tetraalkylphosphonium, trialkylsulfonium, 1-butyl-3-methylimidazolium hexafluorophosphate (bmimPF₆), 1-butyl-3-methylimidazolium acetate (bmimACET), 1-butyl-3-methylimidazolium thiocyanate (bmimSCN), EMITFSI, [Cₙmim][TFSI] or [Cₙmim][FSI] (n=2, 4), 1-ethyl-3-methylimidazolium bis(fluorosulfonyl)imide ([C2mim][FSI]), N-methyl-N-propylpyrrolidinium bis(fluorosulfonyl)imide ([Pry13][FSI]), 1-Ethyl-3-methylimidazolium bis(trifluoromethylsulfonyl)imide ([EMIM][TFSI]), 1-Ethyl-3-methylimidazolium trifluoromethanesulfonate ([EMIM][Tf]) and 1-Butyl-3-methylimidazolium dicyanamide ([BMIM][DCA]), or a combination thereof.

The ionic liquid in the interface enhancer composition may be selected from a room temperature ionic liquid having an anion selected from BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, a thiocyanate anion, or a combination thereof.

In certain embodiments, the organic solvent in the interface enhancer composition is selected from a fluorinated carbonate, hydrofluoroether, fluorinated ester, fluorinated vinyl carbonate, fluorinated ether, fluorinated vinyl ester, and fluorinated vinyl ether, sulfone, nitrile, phosphate, phosphite, alkyl phosphonate, phosphazene, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), gamma-butyrolactone (Y-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a fluorinated solvent, a sulfone, a sulfide, a nitrile, a phosphate, a phosphite, a phosphonate, a phosphazene, a sulfate, a siloxane, Glyme, a chemical derivative thereof, or a combination thereof. Preferably, the liquid or the polymer in the interface enhancer composition includes a lithium salt of 0.1%-50% by weight dispersed therein.

Most of these liquids are polymerizable or cross-linkable; e.g., those organic compounds containing unsaturated C═C bonds, cyclic carbonates, cyclic esters, cyclic ethers, and combinations thereof. In the lithium-ion battery or lithium metal battery industry, the liquid solvents listed above are commonly used as a solvent to dissolve a lithium salt therein and the resulting solutions are used as a liquid electrolyte. It is uniquely advantageous to be able to polymerize the liquid solvent once injected into an anode, a cathode, a solid-state electrolyte, or a battery cell, enabling the formation of a contiguous lithium salt-containing solid polymer phase. With such a novel strategy, one can readily reduce the liquid solvent or completely eliminate the liquid solvent all together. This is of significant utility value since most of the organic solvents are known to be volatile and flammable, posing a fire and explosion danger.

Desirable liquid solvents include fluorinated monomers having unsaturation (double bonds or triple bonds that can be opened up for polymerization); e.g., fluorinated vinyl carbonates, fluorinated vinyl monomers, fluorinated esters, fluorinated vinyl esters, and fluorinated vinyl ethers). Fluorinated vinyl esters include R_{f}CO₂CH═CH₂ and Propenyl Ketones, R_{f}COCH═CHCH₃, where R_{f} is For any F-containing functional group (e.g., CF₂— and CF₂CF₃—).

Two examples of fluorinated vinyl carbonates are given below:

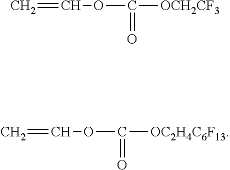

These liquid solvents, as a monomer, can be cured in the presence of an initiator (e.g., 2-Hydroxy-2-methyl-1-phenyl-propan-1-one, Ciba DAROCUR-1173, which can be activated by UV or electron beam):

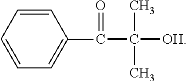

In some embodiments, the fluorinated carbonate is selected from vinyl- or double bond-containing variants of fluoroethylene carbonate (FEC), DFDMEC, FNPEC, a combination thereof, or a combination thereof with hydrofluoro ether (HFE), trifluoro propylene carbonate (FPC), or methyl nonafluorobutyl ether (MFE), wherein the chemical formulae for FEC, DFDMEC, and FNPEC, respectively (all polymerizable via ring-opening polymerization with an ionic initiator) are shown below:

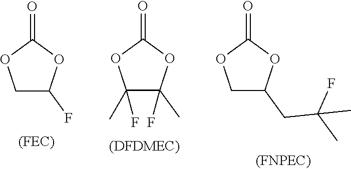

Desirable sulfones as a polymerizable liquid solvent include, but not limited to, alkyl and aryl vinyl sulfones or sulfides; e.g., ethyl vinyl sulfide, allyl methyl sulfide, phenyl vinyl sulfide, phenyl vinyl sulfoxide, ethyl vinyl sulfone, allyl phenyl sulfone, allyl methyl sulfone, and divinyl sulfone.

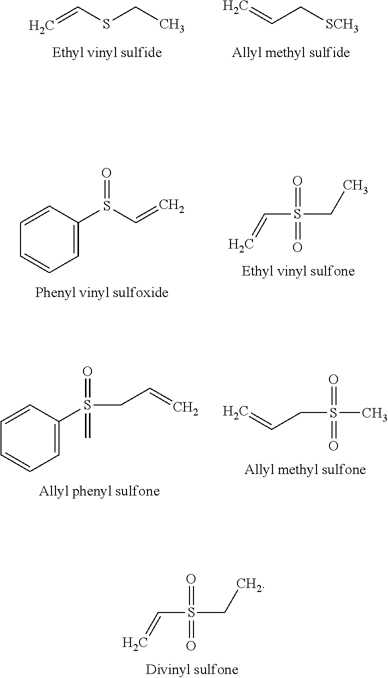

Simple alkyl vinyl sulfones, such as ethyl vinyl sulfone, may be polymerized via emulsion and bulk methods. Propyl vinyl sulfone may be polymerized by alkaline persulfate initiators to form soft polymers. It may be noted that aryl vinyl sulfone, e.g., naphthyl vinyl sulfone, phenyl vinyl sulfone, and parra-substituted phenyl vinyl sulfone (R═NH₂, NO₂ or Br), were reported to be unpolymerizable with free-radical initiators. However, we have observed that phenyl and methyl vinyl sulfones can be polymerized with several anionic-type initiators. Effective anionic-type catalysts or initiators are n-BuLi, ZnEt2, LiN(CH₂)₂, NaNH₂, and complexes of n-LiBu with ZnEt2 or AlEh. A second solvent, such as pyridine, sulfolane, toluene or benzene, can be used to dissolve alkyl vinyl sulfones, aryl vinyl sulfones, and other larger sulfone molecules.

Poly(sulfone)s have high oxygen indices and low smoke emission on burning. Poly(sulfone)s are inherently self-extinguishing materials owing to their highly aromatic character. A hydroxy-terminated copoly(ester sulfone) synthesized by melt polycondensation of the diethylene glycol and 4,4-dihydroxydiethoxydiphenyl sulfone with adipic acid can be used as a flame retardant. Some examples are difunctional β-allyl sulfones and 4,4¢-(m-phenylene-dioxy)bis(benzenesulfonyl chloride):

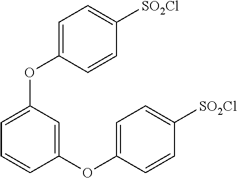 [SMILES: O=S(=O)(Cl)c1ccc(Oc2cccc(Oc3ccc(S(=O)(=O)Cl)cc3)c2)cc1]

Bisphenol S (BPS) and 4,4′-Dichlorodiphenyl sulfone (DCDPS) are additional examples that can be a part of a polymer structure. Bisphenol S (BPS) is an organic compound with the formula (HOC₆H₄)₂SO₂:

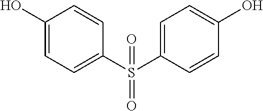 [SMILES: O=S(=O)(c1ccc(O)cc1)c1ccc(O)cc1]

4,4′-Dichlorodiphenyl sulfone (DCDPS), having a MP=148° C., is an organic compound with the formula (ClC₆H₄)₂SO₂:

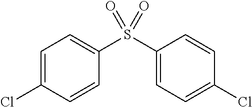 [SMILES: O=S(=O)(c1ccc(Cl)cc1)c1ccc(Cl)cc1]

In certain embodiments, the sulfone is selected from TrMS, MTrMS, TMS, or vinyl or double bond-containing variants of TrMS, MTrMS, TMS, EMS, MMES, EMES, EMEES, or a combination thereof; their chemical formulae being given below:

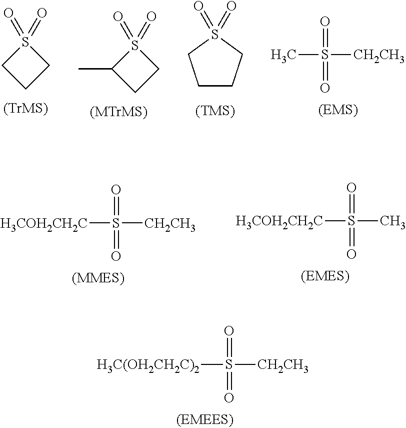

The cyclic structure, such as TrMS, MTrMS, and TMS, can be polymerized via ring-opening polymerization with the assistance of an ionic type initiator.

The nitrile may be selected from AND, GLN, SEN, SN, or a combination thereof and their chemical formulae are given below:

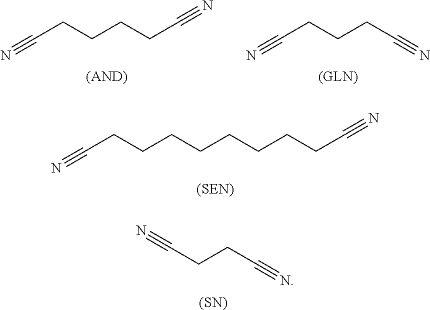

In some embodiments, the phosphate (including various derivatives of phosphoric acid), alkyl phosphonate, phosphazene, phosphite, or sulfate is selected from tris(trimethylsilyl) phosphite (TTSPi), alkyl phosphate, triallyl phosphate (TAP), ethylene sulfate (DTD), a combination thereof, or a combination with 1,3-propane sultone (PS) or propene sultone (PES). The phosphate, alkyl phosphonate, or phosphazene may be selected from the following:

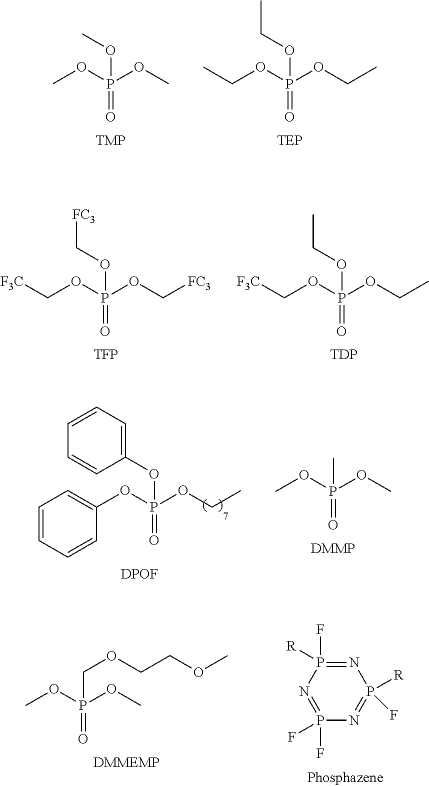

wherein R═H, NH₂, or C₁-C₆ alkyl.

Phosphonate moieties can be readily introduced into vinyl monomers to produce allyl-type, vinyl-type, styrenic-type and (meth)acrylic-type monomers bearing phosphonate groups (e.g., either mono or bisphosphonate). The phosphate, alkyl phosphonate, phosphonic acid, and phosphazene, upon polymerization, are found to be essentially non-flammable. Good examples include diethyl vinylphosphonate, dimethyl vinylphosphonate, vinylphosphonic acid, diethyl allyl phosphate, and diethyl allylphosphonate:

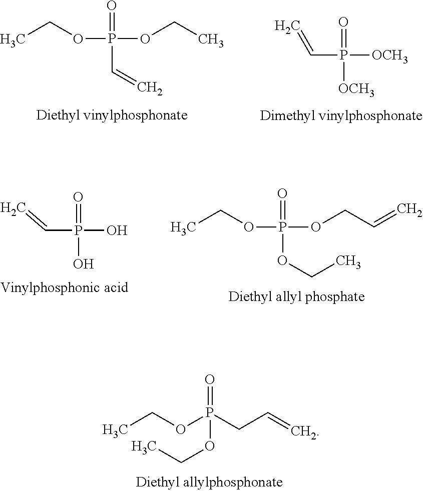

Examples of a polymerizable phosphazene contain derivatives with a general structural formula:

[—NP(A)ₐ(B)_{b}—]ₓ

wherein the groups A and B are bonded to phosphorus atoms through —O—, —S—, —NH—, or —NR— (with R═C₁-C₆) alkyl), and wherein A stands more precisely for a vinyl ether group or a styrene ether group, and B stands more precisely for a hydrocarbon group. In general, A contains at least one vinyl ether group of the general formula Q-O—CR′═CHR″ and/or styrene ether group of the general formula:

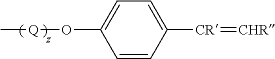

wherein R′ and/or R″ stands for hydrogen or C₁-C₁₀ alkyl; B stands for a reactive or nonreactive hydrocarbon group optionally containing O, S, and/or N, and optionally containing at least one reactive group; Q is an aliphatic, cycloaliphatic, aromatic, and/or heterocyclic hydrocarbon group, optionally containing O, S, and/or N; a is a number greater than 0; b is 0 or a number greater than 0 and a+b=2; x stands for a whole number that is at least 2; and z stands for 0 or 1. Initiators for these phosphazene derivatives can be those of Lewis acids, SbCl₃, AlCl₃, or sulfur compounds.

Examples of initiator compounds that can be used in the polymerization of vinylphosphonic acid are peroxides such as benzoyl peroxide, toluyl peroxide, di-tert.butyl peroxide, chloro benzoyl peroxide, or hydroperoxides such as methylethyl ketone peroxide, tert, butyl hydroperoxide, cumene hydroperoxide, hydrogen Superoxide, or azo-bis-iso-butyro nitrile, or sulfinic acids such as p-methoxyphenyl-sulfinic acid, isoamyl-sulfinic acid, benzene-sulfinic acid, or combinations of various of such catalysts with one another and/or combinations for example, with formaldehyde sodium sulfoxylate or with alkali metal sulfites.

The siloxane or silane may be selected from alkylsiloxane (Si—O), alkyylsilane (Si—C), liquid oligomeric silaxane (—Si—O—Si—), or a combination thereof.

The polymerizable liquid may further include an amide group selected from N,N-dimethylacetamide, N,N-diethylacetamide, N,N-dimethylformamide, N,N-diethylformamide, or a combination thereof.

The crosslinking agent may include a compound having at least one reactive group selected from a hydroxyl group, an amino group, an imino group, an amide group, an acrylic amide group, an amine group, an acrylic group, an acrylic ester group, or a mercapto group in the molecule. In certain embodiments, the crosslinking agent is selected from poly(diethanol) diacrylate, poly(ethyleneglycol) dimethacrylate, poly(diethanol) dimethylacrylate, poly(ethylene glycol) diacrylate, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), or a combination thereof.

The initiator may be selected from an azo compound (e.g., azodiisobutyronitrile, AIBN), azobisisobutyronitrile, azobisisoheptonitrile, dimethyl azobisisobutyrate, benzoyl peroxide tert-butyl peroxide and methyl ethyl ketone peroxide, benzoyl peroxide (BPO), bis(4-tert-butylcyclohexyl) peroxydicarbonate, t-amyl peroxypivalate, 2,2′-azobis-(2,4-dimethylvaleronitrile), 2,2′-azobis-(2-methylbutyronitrile), 1,1-azobis(cyclohexane-1-carbonitrile, benzoylperoxide (BPO), hydrogen peroxide, dodecamoyl peroxide, isobutyryl peroxide, cumene hydroperoxide, tert-butyl peroxypivalate, diisopropyl peroxydicarbonate, or a combination thereof.

The crosslinking agent preferably includes a compound having at least one reactive group selected from a hydroxyl group, an amino group, an imino group, an amide group, an amine group, an acrylic group, or a mercapto group in the molecule. The amine group is preferably selected from Chemical Formula 2:

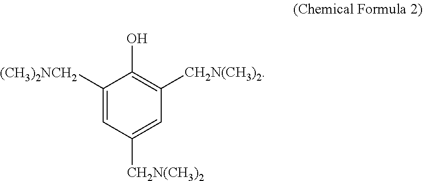

In the rechargeable lithium battery, the polymerizable liquid may further include a chemical species represented by Chemical Formula 3 or a derivative thereof and the crosslinking agent includes a chemical species represented by Chemical Formula 4 or a derivative thereof:

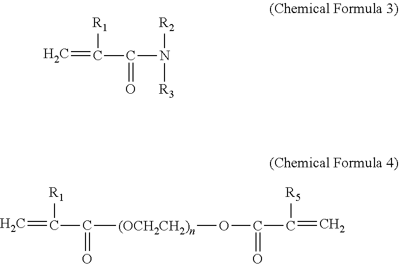

where R₁ is hydrogen or methyl group, and R₂ and R₃ are each independently one selected from the group consisting of hydrogen, methyl, ethyl, propyl, dialkylaminopropyl (—C₃H₆N(R′)₂) and hydroxyethyl (CH₂CH₂OH) groups, and R₄ and R₅ are each independently hydrogen or methyl group, and n is an integer from 3 to 30, wherein R′ is C₁-C₅ alkyl group.

Examples of suitable vinyl monomers having Chemical formula 3 include acrylamide, N,N-dimethylacrylamide, N,N-diethylacrylamide, N-isopropylacrylamide, N,N-dimethylamino-propylacrylamide, and N-acryloylmorpholine. Among these species, N-isopropylacrylamide and N-acryloylmorpholine are preferred.

The crosslinking agent may be selected from N,N-methylene bisacrylamide, epichlorohydrin, 1,4-butanediol diglycidyl ether, tetrabutylammonium hydroxide, cinnamic acid, ferric chloride, aluminum sulfate octadecahydrate, diepoxy, dicarboxylic acid compound, poly(potassium 1-hydroxy acrylate) (PKHA), glycerol diglycidyl ether (GDE), ethylene glycol, polyethylene glycol, polyethylene glycol diglycidyl ether (PEGDE), citric acid (Formula 4 below), acrylic acid, methacrylic acid, a derivative compound of acrylic acid, a derivative compound of methacrylic acid (e.g. polyhydroxyethylmethacrylate), glycidyl functions, N,N′-Methylenebisacrylamide (MBAAm), Ethylene glycol dimethacrylate (EGDMAAm), isobornyl methacrylate, poly(acrylic acid) (PAA), methyl methacrylate, isobornyl acrylate, ethyl methacrylate, isobutyl methacrylate, n-Butyl methacrylate, ethyl acrylate, 2-Ethyl hexyl acrylate, n-Butyl acrylate, a diisocyanate (e.g. methylene diphenyl diisocyanate, MDI), an urethane chain, a chemical derivative thereof, or a combination thereof.

The inorganic solid electrolyte material may be selected from an oxide type, sulfide type (including, but not limited to, the thio-LISICON type, glass-type, glass ceramic-type, and argyrodite-type sulfide electrolyte), hydride type, halide type, borate type, phosphate type, lithium phosphorus oxynitride (LiPON), garnet-type, lithium superionic conductor (LISICON) type, sodium superionic conductor (NASICON) type, or a combination thereof.

The inorganic solid electrolyte particles that can be incorporated into the hybrid electrolyte include, but are not limited to, perovskite-type, NASICON-type, garnet-type and sulfide-type materials. A representative perovskite solid electrolyte is Li₃ₓLa_{2/3-x}TiO₃, which exhibits a lithium-ion conductivity exceeding 10⁻³ S/cm at room temperature. This material has been deemed unsuitable in lithium batteries because of the reduction of Ti⁴⁺ on contact with lithium metal. However, we have found that this material, when dispersed in a polymer, does not suffer from this problem.

The sodium superionic conductor (NASICON)-type compounds include a well-known Na₁₊ₓZr₂SiₓP₃₋ₓO₁₂. These materials generally have an AM₂(PO₄)₃ formula with the A site occupied by Li, Na or K. The M site is usually occupied by Ge. Zr or Ti. In particular, the LiTi₂(PO₄)₃ system has been widely studied as a solid-state electrolyte for the lithium-ion battery. The ionic conductivity of LiZr₂(PO₄)₃ is very low, but can be improved by the substitution of Hf or Sn. This can be further enhanced with substitution to form Li₁₊ₓMₓTi₂₋ₓ(PO₄)₃ (M=Al, Cr, Ga, Fe, Sc, In, Lu, Y or La). Al substitution has been demonstrated to be the most effective solid-state electrolyte. The Li₁₊ₓAlₓGe₂₋ₓ(PO₄)₃ system is also an effective solid state due to its relatively wide electrochemical stability window. NASICON-type materials are considered as suitable solid electrolytes for high-voltage solid electrolyte batteries.

Garnet-type materials have the general formula A₃B₂Si₃O₁₂, in which the A and B cations have eightfold and six-fold coordination, respectively. In addition to Li₃M₂Ln₃O₁₂ (M=W or Te), a broad series of garnet-type materials may be used as an additive, including Li₅La₃M₂O₁₂(M=Nb or Ta), Li₆ALa₂M₂O₁₂ (A=Ca, Sr or Ba; M=Nb or Ta), Li_{5.5}La₃M_{1.75}B_{0.25}O₁₂ (M=Nb or Ta; B═In or Zr) and the cubic systems Li₇La₃Zr₂O₁₂ and Li_{7.06}M₃Y_{0.06}Zr_{1.94}O₁₂(M=La, Nb or Ta). The Li_{6.5}La₃Zr_{1.75}Te_{0.25}O₁₂ compounds have a high ionic conductivity of 1.02×10⁻³ S/cm at room temperature.

The sulfide-type solid electrolytes include the Li₂S—SiS₂ system. The conductivity in this type of material is 6.9×10⁻⁴ S/cm, which was achieved by doping the Li₂S—SiS₂ system with Li₃PO₄. Other sulfide-type solid-state electrolytes can reach a good lithium-ion conductivity close to 10⁻² S/cm. The sulfide type also includes a class of thio-LISICON (lithium superionic conductor) crystalline material represented by the Li₂S—P₂S₅ system. The chemical stability of the Li₂S—P₂S₅ system is considered as poor, and the material is sensitive to moisture (generating gaseous H₂S). The stability can be improved by the addition of metal oxides. The stability is also significantly improved if the Li₂S—P₂S₅ material is dispersed in an elastic polymer as herein disclosed.

Sulfide-type SSEs that have been successfully synthesized include the LPS class, Li₂S—SiS₂ system, Li₆PS₅X (X═Cl, Br, I, and combinations thereof), and LiₓMP_{y}S_{z} (M=Ge, Sn, Si, Al, and combinations thereof) bases. The lithium thiophosphate or LPS class includes several high-conducting materials. Several sulfide crystalline phases have been found, of which the type of crystal formed depends on the heat treatment applied and the composition of the glass formed. The sulfide crystalline phases include: Li₃PS₄, Li₇P₃S₁₁, Li₇PS₆ and Li₄P₂S₆. The derivatives of Li₆PS₅X include Li_{6-y}PS_{5-y}Cl_{1+y}, Li_{6-y}PS_{5-y}Br_{1+y}, and Li_{6-y}PS_{5-y}I_{1+y} (with y=0-0.5), etc. Examples of LiₓMP_{y}S_{z} (M=Ge, Sn, Si, Al, and combinations thereof) include Li₁₀GeP₂S₁₂, Li₁₀SnP₂S₁₂, Li₁₀SiP₂S₁₂, and LinAlP₂S₁₂, Li₁₀Si_{0.3}Sn_{0.7}P₂S₁₂, etc. The particles of all these sulfide-type inorganic electrolytes may be used in the presently disclosed composite particulates.

These inorganic solid electrolyte (ISE) particles embedded in a polymer matrix can help enhance the lithium ion conductivity. Preferably and typically, the polymer electrolyte has a lithium ion conductivity no less than 10⁻⁵ S/cm, more desirably no less than 10⁻⁴ S/cm, further preferably no less than 10⁻³ S/cm, and most preferably no less than 10⁻² S/cm.

It should be noted that certain inorganic solid electrolytes (e.g., sulfide type ISE) can have a higher lithium-ion conductivity as compared to certain selected polymers. However, sulfide type ISEs are air-sensitive and air-sensitive and, hence, cannot be combined with an anode active material (e.g., graphite or Si) to form an anode using water as a liquid medium in a commonly used slurry coating process. Furthermore, sulfide-type ISEs have a very narrow electrochemical stability window (e.g., from 1.8-2.5 V relative to Li/Li⁺), making them unsuitable for use in the anode, where lithium ion intercalation occurs at approximately 0.23 V for graphite and 0.5 V for Si (significantly lower than 1.8 V). They are also unsuitable for the cathode since the cathode active material typically operates at 3.2-4.4 V for lithium iron phosphate and all lithium transition metal oxides. We have solved this problem by embedding the ISE particles in a polymer electrolyte that typically has a significantly wider electrochemical stability window (e.g., can be from 0 to 4.5 v relative to Li/Li⁺), the polymer protection also enables the ISEs processible using the current lithium-ion cell production processes.

These solid electrolyte particles dispersed in an electrolyte polymer can help enhance the lithium ion conductivity of certain polymers otherwise having an intrinsically low ion conductivity. Preferably and typically, the polymer has a lithium ion conductivity no less than 10⁻⁵ S/cm, more preferably no less than 10⁻⁴ S/cm, further preferably no less than 10⁻³ S/cm, and most preferably no less than 10⁻² S/cm.

In some embodiments, the polymer/inorganic composite electrolyte includes particles of inorganic material selected from SiO₂, TiO₂, Al₂O₃, MgO₂, ZnO₂, ZnO₂, CuO, CdO, Li₂CO₃, Li₂O, Li₂C₂O₄, LiOH, LIX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

The solid-state electrolyte may include a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer (e.g., those with a carboxylate anion, a sulfonylimide anion, or sulfonate anion), poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), an acrylic polymer, a butyl acrylate rubber, polyphosphate, polyphosphite, polyphosphonate, polyphosphazenes, polytetrahydrofuran, a copolymer thereof, a semi-penetrating network thereof, a sulfonated derivative thereof, or a combination thereof.

As indicated earlier, the first or second solid-state electrolyte may include an elastomer. An elastomer refers to a polymer, typically a lightly cross-linked polymer, which exhibits an clastic deformation that is at least 2% (preferably at least 5%) when measured under uniaxial tension. In the field of materials science and engineering, the “elastic deformation” is defined as a deformation of a material (when being mechanically stressed) that is essentially fully recoverable upon release of the load and the recovery process is essentially instantaneous (no or little time delay). Metals and plastics can be stretched beyond 2% or even beyond 100%, but these deformations are plastic deformations (permanent deformations) that are not recoverable upon release of the mechanical load.

The elastic deformation is more preferably greater than 10%, even more preferably greater than 30%, further more preferably greater than 50%, and still more preferably greater than 100%. The elasticity of the elastic polymer alone (without any additive dispersed therein) can be as high as 1,000%. However, the elasticity can be significantly reduced if a certain amount of inorganic filler is added into the polymer. Depending upon the type and proportion of the additive incorporated, the reversible elastic deformation is typically reduced to the range of 2%-500%, more typically 2%-300%.

The elastomer may be selected from natural polyisoprene, synthetic polyisoprene, polybutadiene, chloroprene rubber, polychloroprene, butyl rubber, poly(butyl diacrylate), styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof.

In some preferred embodiments, the elastomer contains a lightly cross-linked network of polymer chains having an ether linkage, nitrile-derived linkage, benzo peroxide-derived linkage, ethylene oxide linkage, ethylene glycol linkage (e.g., ethylene glycol diacrylate chains), propylene oxide linkage, vinyl alcohol linkage, cyano-resin linkage, triacrylate monomer-derived linkage, tetraacrylate monomer-derived linkage, or a combination thereof, in the cross-linked network of polymer chains having a degree of crosslinking that affords an elasticity of the polymer in the range from 5% to 1,000%. These network or cross-linked polymers exhibit a unique combination of a high elasticity (high elastic deformation strain) and high lithium-ion conductivity.

In certain preferred embodiments, the elastomer contains a lightly cross-linked network of polymer chains selected from nitrile-containing polyvinyl alcohol chains, cyanoresin chains, pentaerythritol tetraacrylate (PETEA) chains, pentaerythritol triacrylate chains, ethoxylated trimethylolpropane triacrylate (ETPTA) chains, ethylene glycol methyl ether acrylate (EGMEA) chains, poly(ethylene glycol) diacrylate (PEGDA) chains, acrylic acid-derived chains, polyvinyl alcohol chains, or a combination thereof.

In certain desired embodiments, the elastomer includes from 5% to 95% by weight (preferably from 25% to 75%, more preferably from 35% to 65%, and most preferably from 45% to 55%) of a lithium ion-conducting plastic crystal or organic domain phase dispersed in or connected to the high-elasticity polymer. Preferably, the elastomer and the plastic crystal or organic domain phase form co-continuous phases exhibiting a lithium-ion conductivity no less than 10⁻⁵ S/cm.

The plastic crystal or organic domain phase typically and desirably includes a mixture of a lithium salt and a lithium ion conducting organic species. These organic species preferably have a relatively high dielectric constant (preferably >5, more preferably >20, and further preferably >50) that is conducive to dissolving a suitable amount of a lithium salt. The mixture should also have chemical compatibility with the crosslinked network of chains and can be readily impregnated into the nano-scaled spaces between these chains. The chains of the elastomer serve to hold the mixture in place.

The desirable organic species in the plastic crystal phase/organic domain may be selected from a fluorinated carbonate, hydrofluoroether, fluorinated vinyl carbonate, fluorinated ester, fluorinated vinyl ester, fluorinated vinyl ether, sulfone, sulfide, nitrile, succino-nitrile, phosphate, phosphite, phosphonate, sulfate, siloxane, silane. 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfolane, acetonitrile (AN), fluoroethylene carbonate (FEC), an ionic liquid solvent, a polymerized version thereof, or a combination thereof. The polymerized versions of these polymers preferably have a low molecular weight, having a number average molecular weight, Mn, preferably less than 10,000 g/mole (more preferably <5,000 g/mole and further more preferably <2,000 g/mole).

As schematically illustrated in FIG. 2(A), one unique feature of the presently disclosed anode-less lithium cell is the notion that there is substantially no anode active material and no lithium metal is present when the battery cell is made. The commonly used anode active material, such as an intercalation type anode material (e.g., graphite, carbon particles, Si, SiO, Sn, SnO₂, Ge, etc.), P, or any conversion-type anode material, is not included in the cell. The anode only contains a current collector or a protected current collector. A layer of the first solid state electrolyte is deposited on the current collector. No lithium metal (e.g., Li particle, surface-stabilized Li particle, Li foil, Li chip, etc.) is present in the anode when the cell is made; lithium is basically stored in the cathode (e.g., Li element in LiCoO₂, LiMn₂O₄, lithium iron phosphate, lithium polysulfides, lithium polyselenides, etc.). During the first charge procedure after the cell is sealed in a housing (e.g., a stainless steel hollow cylinder or an Al/plastic laminated envelop), lithium ions are released from these Li-containing compounds (cathode active materials) in the cathode, travel through the electrolyte/separator into the anode side, and get deposited on the surfaces of an anode current collector. During a subsequent discharge procedure, lithium ions leave these surfaces and travel back to the cathode, intercalating or inserting into the cathode active material.

Such an anode-less cell is much simpler and more cost-effective to produce since there is no need to have a layer of anode active material (e.g., graphite particles, along with a conductive additive and a binder) pre-coated on the Cu foil surfaces via the conventional slurry coating and drying procedures. The equipment for slurry coating and drying occupies a large space (can be as long as 120 meters long) in a cell production facility and is typically very expensive. The anode materials and anode active layer manufacturing costs can be saved in the presently disclosed anodeless cell. A simple and low-cost spraying, casting, or coating procedure can be used to deposit a thin layer of a first solid state electrolyte on the anode current collector. The thickness of the first solid state electrolyte is preferably from 5 nm to 50 μm, preferably from 10 nm to 20 μm. Furthermore, since there is no anode active material layer (otherwise typically 40-200 μm thick), the weight and volume of the cell can be significantly reduced, thereby increasing the gravimetric and volumetric energy density of the cell.

Another important advantage of the anode-less cell is the notion that there is no lithium metal in the anode when a lithium metal cell is made. Lithium metal (e.g., Li metal foil and particles) is highly sensitive to air moisture and oxygen and notoriously known for its difficulty and danger to handle during manufacturing of a Li metal cell. The manufacturing facilities should be equipped with special class of dry rooms, which are expensive and significantly increase the battery cell costs.

The anode current collector may be selected from a foil, perforated sheet, or foam of Cu, Ni, stainless steel, Al, graphene, graphite, graphene-coated metal, graphite-coated metal, carbon-coated metal, or a combination thereof. Preferably, the current collector is a Cu foil, Ni foil, stainless steel foil, graphene-coated Al foil, graphite-coated Al foil, or carbon-coated Al foil.

The anode current collector typically has two primary surfaces. Preferably, one or both of these primary surfaces is deposited with multiple particles or coating of a lithium-attracting metal (lithiophilic metal), wherein the lithium-attracting metal, preferably having a diameter or thickness from 1 nm to 10 μm, is selected from Au, Ag, Mg, Zn, Ti, K, Al, Fe, Mn, Co, Ni, Sn, V, Cr, an alloy thereof, or a combination thereof. This deposited metal layer may be further deposited with a layer of graphene that covers and protects the multiple particles or coating of the lithiophilic metal.

The graphene layer may include graphene sheets selected from single-layer or few-layer graphene, wherein the few-layer graphene sheets are commonly defined to have 2-10 layers of stacked graphene planes having an inter-plane spacing doo from 0.3354 nm to 0.6 nm as measured by X-ray diffraction. The single-layer or few-layer graphene sheets may contain a pristine graphene material having essentially zero % of non-carbon elements, or a non-pristine graphene material having 0.001% to 45% by weight of non-carbon elements. The non-pristine graphene may be selected from graphene oxide, reduced graphene oxide, graphene fluoride, graphene chloride, graphene bromide, graphene iodide, hydrogenated graphene, nitrogenated graphene, doped graphene, chemically functionalized graphene, or a combination thereof.

The graphene layer may include graphene balls and/or graphene foam. Preferably, the graphene layer has a thickness from 1 nm to 50 μm and/or has a specific surface area from 5 to 1000 m²/g (more preferably from 10 to 500 m²/g).

In addition to the non-flammability and high lithium ion transference numbers, there are several additional benefits associated with using the presently disclosed solid-state batteries. As one example, a combination of a solid-state electrolyte and an interface enhancer composition properly disposed inside a cathode active layer and/or anode active layer, and disposed between a solid-state electrolyte layer and an electrode (anode or cathode) can significantly enhance cycling and safety performance of rechargeable lithium batteries through effective suppression of lithium dendrite growth. Due to a good contact between the electrolyte and an electrode, the interfacial impedance can be significantly reduced. These reasons, separately or in combination, are believed to be responsible for the notion that no dendrite-like feature has been observed with any of the large number of rechargeable lithium cells that we have investigated thus far.

As another benefit example, this combination of solid-state electrolyte and an interface enhancer composition in the cathode is capable of inhibiting diffusion of lithium polysulfide from the cathode, through the solid-state electrolyte layer and to the anode of a Li—S cell, thus overcoming the polysulfide shuttle phenomenon and allowing the cell capacity not to decay significantly with time. Consequently, a coulombic efficiency nearing 100% along with long cycle life can be achieved.

The lithium salt may be selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

The ionic liquid is composed of ions only. Ionic liquids are low melting temperature salts that are in a molten or liquid state when above a desired temperature. For instance, an ionic salt is considered as an ionic liquid if its melting point is below 100° C. If the melting temperature is equal to or lower than room temperature (25° C.), the salt is referred to as a room temperature ionic liquid (RTIL). The IL-based lithium salts are characterized by weak interactions, due to the combination of a large cation and a charge-delocalized anion. This results in a low tendency to crystallize due to flexibility (anion) and asymmetry (cation).

Some ILs may be used alone or as a co-solvent (not as a salt) to work with the an organic solvent of the present invention. A well-known ionic liquid is formed by the combination of a 1-ethyl-3-methyl-imidazolium (EMI) cation and an N,N-bis(trifluoromethane) sulphonamide (TFSI) anion. This combination gives a fluid with an ionic conductivity comparable to many organic electrolyte solutions, a low decomposition propensity and low vapor pressure up to ˜300-400° C. This implies a generally low volatility and non-flammability and, hence, a much safer electrolyte solvent for batteries.

Ionic liquids are basically composed of organic or inorganic ions that come in an unlimited number of structural variations owing to the preparation ease of a large variety of their components. Thus, various kinds of salts can be used to design the ionic liquid that has the desired properties for a given application. These include, among others, imidazolium, pyrrolidinium and quaternary ammonium salts as cations and bis(trifluoromethanesulphonyl) imide, bis(fluorosulphonyl)imide and hexafluorophosphate as anions. Useful ionic liquid-based lithium salts (not solvent) may be composed of lithium ions as the cation and bis(trifluoromethanesulphonyl)imide, bis(fluorosulphonyl)imide and hexafluorophosphate as anions. For instance, lithium trifluoromethanesulfonimide (LiTFSI) is a particularly useful lithium salt.

Based on their compositions, ionic liquids come in different classes that include three basic types: aprotic, protic and zwitterionic types, each one suitable for a specific application.

Common cations of room temperature ionic liquids (RTILs) include, but are not limited to, tetraalkylammonium, di, tri, and tetra-alkylimidazolium, alkylpyridinium, dialkyl-pyrrolidinium, dialkylpiperidinium, tetraalkylphosphonium, and trialkylsulfonium. Common anions of RTILs include, but are not limited to, BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, etc. Relatively speaking, the combination of imidazolium- or sulfonium-based cations and complex halide anions such as AlCl₄⁻, BF₄⁻, CF₃CO₂⁻, CF₃SO₃⁻, NTf₂⁻, N(SO₂F)₂⁻, or F(HF)_{2.3}⁻ results in RTILs with good working conductivities.

RTILs can possess archetypical properties such as high intrinsic ionic conductivity, high thermal stability, low volatility, low (practically zero) vapor pressure, non-flammability, the ability to remain liquid at a wide range of temperatures above and below room temperature, high polarity, high viscosity, and wide electrochemical windows. These properties, except for the high viscosity, are desirable attributes when it comes to using an RTIL as an electrolyte co-solvent in a rechargeable lithium cell.

There is also no restriction on the type of the cathode materials that can be used in practicing the present disclosure. For Li—S cells, the cathode active material may contain lithium polysulfide or sulfur. If the cathode active material includes lithium-containing species (e.g., lithium polysulfide) when the cell is made, there is no need to have a lithium metal pre-implemented in the anode.

There are also no particular restrictions on the types of cathode active materials that can be used in the presently disclosed lithium battery (lithium-ion or lithium metal battery), which can be a primary battery or a secondary battery. The rechargeable lithium metal or lithium-ion cell may preferably contain a cathode active material selected from, as examples, a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

In a rechargeable lithium cell, the cathode active material may be selected from a metal oxide, a metal oxide-free inorganic material, an organic material, a polymeric material, sulfur, lithium polysulfide, selenium, or a combination thereof. The metal oxide-free inorganic material may be selected from a transition metal fluoride, a transition metal chloride, a transition metal dichalcogenide, a transition metal trichalcogenide, or a combination thereof. In a particularly useful embodiment, the cathode active material is selected from FeF₃, FeCl₃, CuCl₂, TiS₂, TaS₂, MoS₂, NbSc₃, MnO₂, CoO₂, an iron oxide, a vanadium oxide, or a combination thereof, if the anode contains lithium metal as the anode active material. The vanadium oxide may be preferably selected from the group consisting of VO₂, LiₓVO₂, V₂O₅, LiₓV₂O₅, V₃O₈, LiₓV₃O₈, LiₓV₃O₇, V₄O₉, LiₓV₄O₉, V₆O₁₃, LiₓV₆O₁₃, their doped versions, their derivatives, and combinations thereof, wherein 0.1<x<5. For those cathode active materials containing no Li element therein, there should be a lithium source implemented in the cathode side to begin with. This can be any compound that contains a high lithium content, or a lithium metal alloy, etc.

In a rechargeable lithium cell (e.g., the lithium-ion battery cell), the cathode active material may be selected to contain a layered compound LiMO₂, spinel compound LiM₂O₄, olivine compound LiMPO₄, silicate compound Li₂MSiO₄, Tavorite compound LiMPO₄F, borate compound LiMBO₃, or a combination thereof, wherein M is a transition metal or a mixture of multiple transition metals.

Particularly desirable cathode active materials include lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), or lithium nickel manganese oxide (LiNi_{q}Mn_{2-q}O₄, 0<q<2).

In a preferred lithium metal secondary cell, the cathode active material preferably contains an inorganic material selected from: (a) bismuth selenide or bismuth telluride, (b) transition metal dichalcogenide or trichalcogenide, (c) sulfide, selenide, or telluride of niobium, zirconium, molybdenum, hafnium, tantalum, tungsten, titanium, cobalt, manganese, iron, nickel, or a transition metal; (d) boron nitride, or (e) a combination thereof. Again, for those cathode active materials containing no Li element therein, there should be a lithium source implemented in the cathode side to begin with.

In another preferred rechargeable lithium cell (e.g. a lithium metal secondary cell or a lithium-ion cell), the cathode active material contains an organic material or polymeric material selected from Poly(anthraquinonyl sulfide) (PAQS), lithium oxocarbons (including squarate, croconate, and rhodizonate lithium salts), oxacarbon (including quinines, acid anhydride, and nitrocompound), 3,4,9,10-perylenetetracarboxylic dianhydride (PTCDA), poly(anthraquinonyl sulfide), pyrene-4,5,9,10-tetraone (PYT), polymer-bound PYT, Quino (triazene), redox-active organic material (redox-active structures based on multiple adjacent carbonyl groups (e.g., “C₆O₆”-type structure, oxocarbons), Tetracyanoquinodimethane (TCNQ), tetracyanoethylene (TCNE), 2,3,6,7,10, 11-hexamethoxytriphenylene (HMTP), poly(5-amino-1,4-dyhydroxy anthraquinone) (PADAQ), phosphazene disulfide polymer ([(NPS₂)₃]n), lithiated 1,4,5,8-naphthalenetetraol formaldehyde polymer, Hexaazatrinaphtylene (HATN), Hexaazatriphenylene hexacarbonitrile (HAT(CN)₆), 5-Benzylidene hydantoin, Isatine lithium salt, Pyromellitic diimide lithium salt, tetrahydroxy-p-benzoquinone derivatives (THQLi₄), N,N′-diphenyl-2,3,5,6-tetraketopiperazine (PHP), N,N′-diallyl-2,3,5,6-tetraketopiperazine (AP), N,N′-dipropyl-2,3,5,6-tetraketopiperazine (PRP), a thioether polymer, a quinone compound, 1,4-benzoquinone, 5,7,12,14-pentacenetetrone (PT), 5-amino-2,3-dihydro-1,4-dyhydroxy anthraquinone (ADDAQ), 5-amino-1,4-dyhydroxy anthraquinone (ADAQ), calixquinone, Li₄C₆O₆, Li₂C₆O₆, Li₆C₆O₆, or a combination thereof.

The thioether polymer may be selected from Poly [methanetetryl-tetra(thiomethylene)] (PMTTM), Poly(2,4-dithiopentanylene) (PDTP), or Poly(ethene-1,1,2,2-tetrathiol) (PETT) as a main-chain thioether polymer, in which sulfur atoms link carbon atoms to form a polymeric backbones. The side-chain thioether polymers have polymeric main-chains that include conjugating aromatic moieties, but having thioether side chains as pendants. Among them Poly(2-phenyl-1,3-dithiolane) (PPDT), Poly(1,4-di(1,3-dithiolan-2-yl)benzene) (PDDTB), poly(tetrahydrobenzodithiophene) (PTHBDT), and poly [1,2,4,5-tetrakis(propylthio)benzene] (PTKPTB) have a polyphenylene main chain, linking thiolane on benzene moieties as pendants. Similarly, poly [3,4 (ethylenedithio) thiophene] (PEDTT) has polythiophene backbone, linking cyclo-thiolane on the 3,4-position of the thiophene ring.

In yet another preferred rechargeable lithium cell, the cathode active material contains a phthalocyanine compound selected from copper phthalocyanine, zinc phthalocyanine, tin phthalocyanine, iron phthalocyanine, lead phthalocyanine, nickel phthalocyanine, vanadyl phthalocyanine, fluorochromium phthalocyanine, magnesium phthalocyanine, manganous phthalocyanine, dilithium phthalocyanine, aluminum phthalocyanine chloride, cadmium phthalocyanine, chlorogallium phthalocyanine, cobalt phthalocyanine, silver phthalocyanine, a metal-free phthalocyanine, a chemical derivative thereof, or a combination thereof. This class of lithium secondary batteries has a high capacity and high energy density. Again, for those cathode active materials containing no Li element therein, there should be a lithium source implemented in the cathode side to begin with.

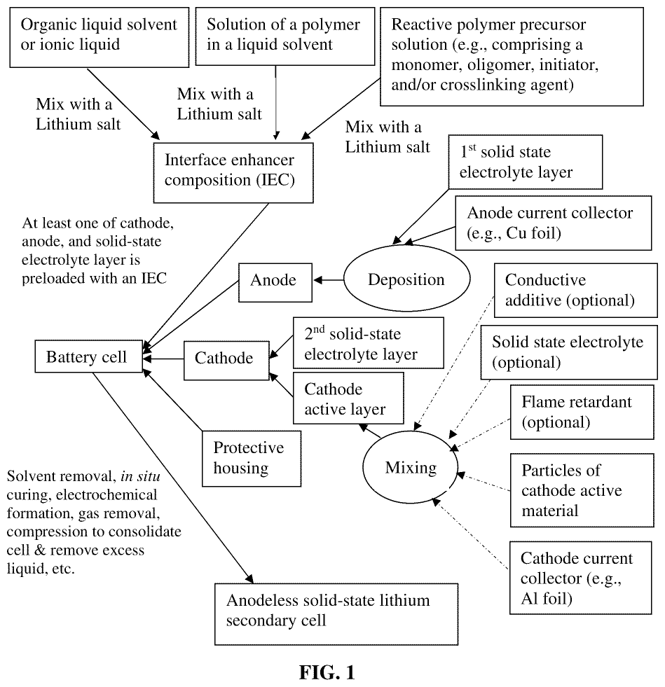

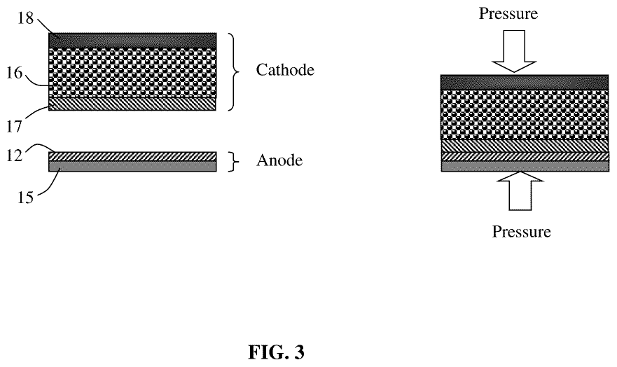

As illustrated in FIG. 1 and FIG. 3, the present disclosure also provides a method of producing the disclosed rechargeable lithium cell, the method comprising: (a) preparing an anode including an anode current collector and a first solid state electrolyte layer deposited on a primary surface of the anode current collector; (b) preparing a cathode including a cathode active layer supported on a cathode current collector and a second solid state electrolyte layer deposited on the cathode active layer, wherein the cathode active layer includes particles of a cathode active material, from 0.1% to 10% by weight of a conductive additive, optionally from 0.1% to 20% by weight of the second solid state electrolyte, and pores occupying from 1% to 40% by volume of the cathode active layer; (c) introducing or depositing an interface enhancer composition into the pores of the cathode active layer, onto or into the first solid state electrolyte layer, and/or onto or into the second solid state electrolyte layer; and (d) combining (e.g., stacking, laminating together, etc.) the anode and the cathode, with the first solid state electrolyte layer facing the second solid state electrolyte layer (FIG. 3), and a protective housing to form the lithium cell. Compressing of the cell may be conducted by using roll-pressing, hot/cold press compression, etc., which exerts a pressure to the stack including the anode and the cathode.

In certain embodiments, the method further includes a Step (e) of conducting electrochemical formation of the cell by charging and discharging the cell at least one cycle, optionally removing formation-induced gaseous species from the cell, sealing the cell, and/or compressing the cell to produce the rechargeable lithium cell.

In certain embodiments, Step (c) of introducing or depositing the interface enhancer composition includes at least one of the following procedures: (i) preparing a liquid solution including an organic solvent and a lithium salt dissolved therein and (A) impregnating the liquid solution into pores of the cathode, allowing the liquid solution to permeate into the pores or (B) depositing the liquid solution onto a surface of the first or second solid state electrolyte layer, allowing the liquid solution to permeate into either or both solid state electrolyte layers, and then partially or completely removing the organic solvent, leaving behind lithium salt precipitated out in the pores or staying in either or both of solid state electrolyte layers; (ii) preparing an ionic liquid solution including an ionic liquid and a lithium salt dissolved therein and impregnating the ionic liquid solution into the cathode, the first solid state electrolyte, and/or the second solid state electrolyte; (iii) preparing a polymer solution including an organic solvent, a polymer and a lithium salt dissolved in the organic solvent and impregnating the polymer solution into pores of the cathode, allowing the polymer solution to permeate into the pores and then partially or completely removing the organic solvent, leaving behind lithium salt and the polymer precipitated out in the pores, wherein the lithium salt is dispersed in the polymer; and (iv) preparing a reactive polymer precursor solution including a monomer, an oligomer, an initiator and/or a cross-linking agent, and a lithium salt dissolved in the precursor solution, and impregnating the reactive polymer precursor into pores of the cathode, allowing the polymer solution to permeate into the pores and polymerizing and/or crosslinking the precursor solution. The procedure of polymerizing and/or crosslinking may include exposing the reactive polymer precursor to heat, ultraviolet light, high-energy radiation, or a combination thereof.

In certain embodiments, Step (c) includes preloading the first and/or second solid-state electrolyte layers with the interface enhancer composition.

In some embodiments, the cathode active layer further includes 0.1% to 30% by weight of particles of an inorganic solid electrolyte powder in the cathode.

To prepare a cathode as in step (b), an active material (e.g. cathode active material particles, such as NCM, NCA and lithium iron phosphate), a conducting additive (e.g. carbon black, carbon nanotubes, expanded graphite flakes, or graphene sheets), an optional flame-retardant agent, optional solid state electrolyte (e.g., 0.1-30% by weight of a polymer), and/or optional particles of an inorganic solid electrolyte may be dissolved/dispersed in a liquid solvent (e.g., NMP) and mixed to form a slurry or paste. The slurry or paste is then made into a desired electrode shape (e.g. cathode electrode), possibly supported on a surface of a current collector (e.g. an Al foil as a cathode current collector). The resulting cathode layer typically has a porosity level of up to 40% by volume, but can be higher or lower.

The interface enhancer composition may be introduced into the pores of the cathode active layer via spraying, coating casting, printing, painting the interface enhancer onto a surface of the cathode layer or by dipping the cathode layer into the interface enhancer composition.

In some embodiments, this procedure of introducing into pores of a cathode layer, into pores of the first solid state electrolyte layer (or onto a surface of this layer), and/or the second solid-state electrolyte layer (or onto a surface of this layer) may be accomplished by at least one of the following procedures:
(a1) impregnating a liquid solution of an organic solvent and a lithium salt dissolved therein into pores of the cathode or into/onto a first or second solid state electrolyte layer (e.g., by spraying, coating, or printing the liquid solution onto the cathode active layer surface or immersing the cathode active layer in the liquid solution), allowing the liquid solution to permeate into pores and then partially or completely removing the organic solvent, leaving behind lithium salt precipitated out in the pores;
(a2) impregnating a liquid solution of an ionic liquid and a lithium salt dissolved therein into pores of the cathode or into/onto a first or second solid state electrolyte layer (e.g., by spraying, coating, or printing the liquid solution onto the cathode active layer surface or immersing the cathode active layer in the liquid solution), allowing the liquid solution to permeate into pores;
(a3) impregnating a polymer solution, including an organic solvent, a polymer and a lithium salt dissolved in the organic solvent, into pores of the cathode or into/onto a first or second solid state electrolyte layer (e.g., by spraying, coating, or printing the polymer solution onto the cathode active layer surface or immersing the cathode active layer in the liquid solution), allowing the polymer solution to permeate into pores and then partially or completely removing the organic solvent, leaving behind lithium salt and the polymer precipitated out in the pores, wherein the lithium salt is dispersed in the polymer; and
(a4) impregnating a reactive polymer precursor solution, including a monomer, an oligomer, an initiator and/or a cross-linking agent, and a lithium salt dissolved in the precursor solution, into pores of the cathode or into/onto a first or second solid state electrolyte layer (e.g., by spraying, coating, or printing the polymer solution onto the cathode active layer surface or immersing the cathode active layer in the liquid solution), allowing the polymer solution to permeate into pores and then polymerizing and/or crosslinking the precursor solution.

The interface enhancer composition is designed to permeate into the internal structure of the cathode and to be in physical contact or ionic contact with substantially all particles of the cathode active material in the cathode, and to permeate into/onto a first or second solid state electrolyte layer. A compression or pressure can help the permeation of the interface enhancer composition (when still containing some liquid ingredient) into pores and making contact with all cathode active materials.

In some embodiments, the layer of solid-state electrolyte in step (b) is preloaded (e.g., pre-impregnated or pre-coated) with an interface enhancer composition. This preloading procedure may be conducted by a procedure analogous to one of the aforementioned (a1), (a2), (a3), and (a4).

The anode electrode, a cathode electrode, and the enhancer-preloaded solid-state electrolyte layer(s), along with a protective housing, are then combined to form a battery cell.

In some embodiments, step (d) further includes an electrochemical formation procedure, a gas removal procedure, a cell compression procedure, or a combination thereof.

In some embodiments, the interface enhancer composition includes a polymerizable or cross-linkable liquid containing a lithium salt dissolved therein, and the method further includes polymerizing or cross-linking this liquid in the anode, the solid-state electrolyte, or the cathode before, during, or after step C).

The following examples are presented primarily for the purpose of illustrating the best mode practice of the present invention, not to be construed as limiting the scope of the present invention.

### Example 1: Preparation of Inorganic Solid Electrolyte (ISE) Powder, Lithium Nitride Phosphate Compound (LIPON)

Particles of Li₃PO₄ (average particle size 4 μm) and urea were prepared as raw materials; 5 g each of Li₃PO₄ and urea was weighed and mixed in a mortar to obtain a raw material composition. Subsequently, the raw material composition was molded into 1 cm×1 cm×10 cm rod with a molding machine, and the obtained rod was put into a glass tube and evacuated. The glass tube was then subjected to heating at 500° C. for 3 hours in a tubular furnace to obtain a lithium nitride phosphate compound (LIPON). The compound was ground in a mortar into a powder form. These ISE particles can be combined with a polymer to form hybrid solid-state electrolyte particulates for use in an anode, a cathode, and/or a separator.

### Example 2: Preparation of Solid Electrolyte Powder, Lithium Superionic Conductors with the Li₁₀GeP₂S₁₂ (LGPS)-Type Structure

The starting materials, Li₂S and SiO₂ powders, were milled to obtain fine particles using a ball-milling apparatus. These starting materials were then mixed together with P₂S₅ in the appropriate molar ratios in an Ar-filled glove box. The mixture was then placed in a stainless steel pot, and milled for 90 min using a high-intensity ball mill. The specimens were then pressed into pellets, placed into a graphite crucible, and then sealed at 10 Pa in a carbon-coated quartz tube. After being heated at a reaction temperature of 1,000° C. for 5 h, the tube was quenched into ice water. The resulting inorganic solid electrolyte material was then subjected to grinding in a mortar to form a powder sample to be later added as inorganic solid electrolyte particles encapsulated by an intended polymer electrolyte shell.

### Example 3: Preparation of Garnet-Type Inorganic Solid Electrolyte Powder

The synthesis of the c-Li_{6.25}Al_{0.25}La₃Zr₂O₁₂ was based on a modified sol-gel synthesis-combustion method, resulting in sub-micron-sized particles after calcination at a temperature of 650° C. (J. van den Broek, S. Afyon and J. L. M. Rupp, Adv. Energy Mater., 2016, 6, 1600736).

For the synthesis of cubic garnet particles of the composition c-Li_{6.25}Al_{0.25}La₃Zr₂O₁₂, stoichiometric amounts of LiNO₃, Al(NO₃)₃-9H₂O, La(NO₃)₃-6(H₂O), and zirconium (IV) acetylacetonate were dissolved in a water/ethanol mixture at temperatures of 70° C. To avoid possible Li-loss during calcination and sintering, the lithium precursor was taken in a slight excess of 10 wt % relative to the other precursors. The solvent was left to evaporate overnight at 95° C. to obtain a dry xerogel, which was ground in a mortar and calcined in a vertical tube furnace at 650° C. for 15 h in alumina crucibles under a constant synthetic airflow. Calcination directly yielded the cubic phase c-Li_{6.25}Al_{0.25}La₃Zr₂O₁₂, which was ground to a fine powder in a mortar for further processing.

The c-Li_{6.25}Al_{0.25}La₃Zr₂O₁₂ solid electrolyte pellets with relative densities of ˜87±3% made from this powder (sintered in a horizontal tube furnace at 1070° C. for 10 h under O₂ atmosphere) exhibited an ionic conductivity of ˜0.5×10⁻³ S cm⁻¹ (RT). The garnet-type solid electrolyte with a composition of c-Li_{6.25}Al_{0.25}La₃Zr₂O₁₂ (LLZO) in a powder form was encapsulated in several ion-conducting polymers.

### Example 4: Preparation of Sodium Superionic Conductor (NASICON) Type Inorganic Solid Electrolyte Powder

The Na_{3.1}Zr_{1.95}M_{0.05}Si₂PO₁₂ (M=Mg, Ca, Sr, Ba) materials were synthesized by doping with alkaline earth ions at octahedral 6-coordination Zr sites. The procedure employed includes two sequential steps. Firstly, solid solutions of alkaline earth metal oxides (MO) and ZrO₂ were synthesized by high energy ball milling at 875 rpm for 2 h. Then NASICON Na_{3.1}Zr_{1.95}M_{0.05}Si₂PO₁₂ structures were synthesized through solid-state reaction of Na₂CO₃, Zr_{1.95}M_{0.05}O_{3.95}, SiO₂, and NH₄H₂PO₄ at 1260° C.

### Example 5: Ionic Liquid Solvated Lithium Salts as Interfacial Enhancer Compositions

The ionic liquids used in the present study included 1-Ethyl-3-methylimidazolium bis(trifluoromethylsulfonyl)imide ([EMIM][TFSI]), 1-Ethyl-3-methylimida-zolium trifluoromethanesulfonate ([EMIM][Tf]) and 1-Butyl-3-methylimidazolium dicyanamide ([BMIM][DCA]), which were all dried for 72 h at 80° C. under vacuum:

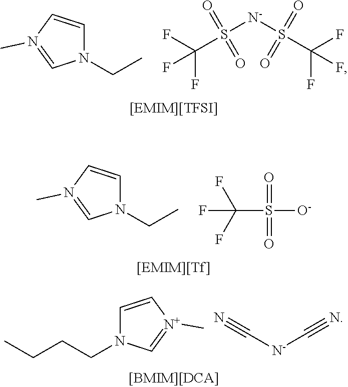

The water content was reduced to be below 10 ppm, as measured by coulometric Karl-Fischer titration. Lithium salts used included Lithium bis(trifluoromethylsulfonyl)imide (LiTFSI), Lithium trifluoromethanesulfonate (LiTf), lithium hexafluoroborate (LiBF₄), lithium nitrate (LiNO₃) and lithium hexafluorophosphate (LiPF₆), which were dried under vacuum. All chemicals were stored in an argon-filled glove box.

Several ionic liquid-lithium salt combinations were prepared for use as interface enhancer compositions: 1.5M of LiTFSI, 1.0M of LiPF₆⁻, and 1.0M of LiBF₄ dissolved in [EMIM][TFSI]; 0.6M of LiNO₃ in [EMIM][Tf]; 0.7 M of LiTf, and 0.6 M of LiPF₆ in [EMIM][Tf]. We have discovered that these ionic liquid-lithium salt systems worked very well with the polymer electrolytes, polymer/inorganic solid composite electrolytes, and various cathode active materials.

### Example 6: Lithium-Ion Cells Featuring an In Situ Polymerized FVC and PEGDA as an Interface Enhancer Composition (IEC) in the 1^{st} and 2^{nd} Solid-State Electrolyte Layers, a Cathode Active Layer, and the Interface Zones Between these Components

In one example, fluorinated vinylene carbonate (FVC) and poly(ethylene glycol) diacrylate (PEGDA) were stirred under the protection of argon gas until a homogeneous solution was obtained. Subsequently, lithium hexafluoro phosphate was then added and dissolved in the above solution to obtain a reactive mixture solution (a precursor interface enhancer composition), wherein the weight fractions of fluorinated vinylene carbonate, poly(ethylene glycol) diacrylate, and lithium hexafluoro phosphate were 85 wt %, 10 wt %, and 5 wt %, respectively.

A 2nd solid-state composite electrolyte layer was made that was composed of particles of Li₇La₃Zr₂O₁₂ embedded in a polyvinylidene fluoride matrix (inorganic solid electrolyte/PVDF ratio=6/4). A LiCoO₂ particle-based cathode active layer was prepared by mixing LiCoO₂ particles, 5% Super-P conductive additive, and 5% PVDF dispersed in NMP to form a slurry, which was coated on an Al foil surface and dried to form a porous cathode. A Cu foil was deposited with a PVDF-HFP polymer layer via a solution spraying procedure using PVDF-HFP/acetone solution. Both the anode (Cu foil coated with the 1^{st} solid state electrolyte layer, PVDF-HFP) and the cathode were then immersed in the precursor interface enhancer composition. The IEC-preloaded anode, the 2^{nd} solid-state electrolyte layer, and the IEC-preloaded cathode were then stacked and laminated inside a protective housing. The cell was then irradiated with electron beam at room temperature until a total dosage of 40 Gy was reached. In-situ polymerization of the polymerizable liquid solvent in the battery cell was accomplished. The cell was electrochemically formed for 3 charge-discharge cycles, degassed, compressed, and re-sealed to form the anodeless lithium metal cell.

### Example 7: Anodeless Lithium Metal Cell Featuring an In Situ Polymerized Phenyl Vinyl Sulfide as an Interface Enhancer Composition in the 1^{st} and 2^{nd} Solid State Electrolyte Layers, and the Cathode Active Layer

The cathode active layer, including NCM-622 particles as a cathode active material, was prepared using a slurry coating process as described in Example 6. The cathode active layer, supported on an Al foil, had pores after removal of the NMP solvent.

Phenyl vinyl sulfide, CTA (chain transfer agent, shown below), AIBN (initiator, 1.0%), and 5% by weight of lithium trifluoro-metasulfonate (LiCF₃SO₃), were mixed to form a reactive precursor solution to the interface enhancer composition (IEC). Two layers of PVDF-HFP as a solid-state electrolyte were soaked in this precursor solution for 2 hours. One of the resulting IEC-preloaded solid-state electrolyte layers was cast onto a Cu foil surface to form an anode. Another layer was cast on the surface of the Al foil-supported cathode active layer to make the cathode. The anode and the cathode were then laminated together with the Pt solid state electrolyte layer facing the 2^{nd} solid state electrolyte layer. The laminate was compressed in a hydraulic press and then was enclosed in a protective envelop and vacuum sealed to form a pouch cell. The vacuum induced compression helped to work the precursor solution into pores in the in the cathode. A certain amount of the precursor solution was also present at the anode/PVDF-HFP and PVDF/cathode interfaces. The cell was heated at 60° C. to obtain a battery cell containing an in situ cued interface enhancer composition that bridged the gaps between the solid-state electrolyte layers and the electrodes. The in situ curing presumably followed the following reaction:

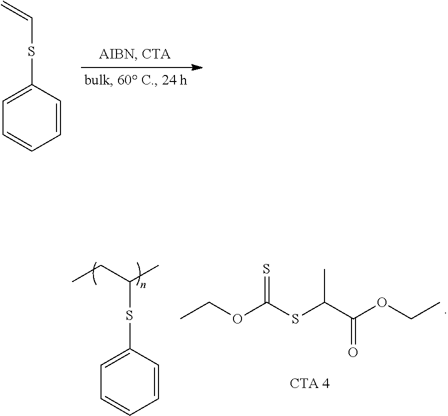

### Example 8: Solid-State Electrolytes and IEC from Poly Vinylphosphonic Acid (VPA)

A porous NCM-622 cathode active layer, coated on an Al foil surface, was prepared using the well-known slurry coating and drying process. An interface enhancer composition (IEC) was prepared by mixing 150 parts vinylphosphonic acid (VPA), 150 parts isopropanol, 0.75 parts benzoyl peroxide and 20 parts of lithium bis(oxalato)borate (LiBOB). Both an anode current collector (Cu foil) and the cathode active layer were coated with the IEC at 60° C., allowing for permeation of the IEC into the pores. Then, most of the isopropanol was removed in a vacuum oven.

In a separate procedure, vinylphosphonic acid was heated to >45° C. (melting point of VPA=36° C.), which was added with benzoyl peroxide, LiBOB, and 50% by weight of a garnet-type solid electrolyte (Li₇La₃Zr₂O₁₂ (LLZO) powder). After rigorous stirring, the resulting paste was cast onto a glass surface to form two separate layers of composite solid electrolyte. A composite solid electrolyte layer was laid over the Cu foil and the other layer was over the cathode active layer. The anode and the cathode were stacked together with the first composite solid state electrolyte layer facing the second solid electrolyte layer. These two composite solid-state electrolyte layers essentially form a separator between an IEC-preloaded anode and an ICE-preloaded cathode active layer to form a cell encased in an Al-PP laminate envelop.

The free radical polymerization of vinylphosphonic acid (VPA) was catalyzed with benzoyl peroxide as the initiator at 90° C. for 5 hours to form an anode-less lithium cell. This was followed by electrochemical formation, degassing, and compression treatments.

Electrochemical measurements (CV curves) were carried out in an electrochemical workstation at a scanning rate of 1-100 mV/s. The electrochemical performance of the cells was evaluated by galvanostatic charge/discharge cycling at a current density of 50-500 mA/g using an Arbin electrochemical workstation. Testing results indicate that the IEC-preloaded solid-state cells exhibit much higher capacity as compared to those without ICE. Furthermore, these cells are flame resistant and relatively safe.

### Example 9: Diethyl Vinylphosphonate and Diisopropyl Vinylphosphonate Polymer Electrolytes in a Lithium/NCM-532 Cell (Initially the Cell being Lithium-Free)

Both diethyl vinylphosphonate and diisopropyl vinylphosphonate were polymerized by a peroxide initiator (di-tert-butyl peroxide), along with LiBF₄, to clear, light-yellow polymers of low molecular weight. In a typical procedure, either diethyl vinylphosphonate or diisopropyl vinylphosphonate (being a liquid at room temperature) is added with di-tert-butyl peroxide (0.5-2% by weight) and LiBF₄ (5-10% by weight) to form a reactive solution.

A NCM-532-based cathode active layer was prepared, which was then impregnated with this reaction solution (a precursor to the IEC) at 45° C. Additionally, layers of diethyl vinylphosphonate and diisopropyl vinylphosphonate polymer electrolytes were cast on glass surfaces and bulk polymerization was allowed to proceed for 2-12 hours at 55° C. After polymerization, they were removed from the glass to obtain free-standing solid-state polymer electrolyte films. For the construction of an anode-less lithium metal cell, a Cu foil anode current collector was combined with a free-standing polymer electrolyte film to form an anode and an IEC-preloaded NCM-532-based cathode was coated with a second free-standing polymer electrolyte film to make a cathode. The anode and the cathode were stacked and housed in a plastic/Al laminated envelop to form a cell. The cells were heated at 55° C. for 6 hours, followed by electrochemical formation, degassing, compression, and scaling.

In some samples, a desired amount (5% by weight based on a total electrode weight) of a flame retardant (e.g. decabromodiphenyl ethane (DBDPE), brominated poly(2,6-dimethyl-1,4-phenylene oxide) (BPPO), and melamine-based flame retardant, separately; the latter from Italmatch Chemicals) was added into the reactive mass.

In several samples, a garnet-type solid electrolyte (Li₇La₃Zr₂O₁₂ (LLZO) powder) was added into the cathode (NCM-532) in the anode-less lithium battery.

### Example 10: In Situ Cured Cyclic Esters of Phosphoric Acid as an Interface Enhancer Composition (IEC), an Elastomer-Coated Cu Foil as an Anode, and Poly(Vinylidene Fluoride)-Hexafluoropropylene (PVDF-HFP)/LGPS as the 2^{nd} Composite Solid-State Electrolyte Layer

Flame-resistant phosphate-based polymer as an IEC ingredient may be synthesized from five-membered cyclic esters of phosphoric acid of the general formula: —CH₂CH(R)OP(O)—(OR′)O— by using n-C₄H₉Li, (C₅H₅)₂Mg, or (i-C₄H₉)₃Al as initiators. The resulting polymers have a repeating unit as follows:

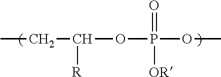

where R is H, with R′═CH₃, C₂H₅, n-C₃H₇, i-C₃H₇; n-C₄H₉, CCl₃CH₂, or C₆H₅, or R is CH₂Cl and R′ is C₂H₅. The polymers typically have Mₙ=10⁴-10⁵.

In a representative procedure, initiators n-C₄H₉Li (0.5% by weight) and 5% lithium bis(oxalato)borate (LiBOB) as a lithium salt were mixed with 2-alkoxy-2-oxo-1,3,2-dioxaphospholan (R′═H in the following chemical formula):

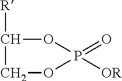

Temperature was used to adjust the viscosity of the reactant mixture, enabling the reactive solution to permeate into pores of a cathode to form IEC-preloaded cathode active layer including NCA particles as a cathode active material.

For the preparation of a polymer/inorganic solid-state electrolyte, PVDF-HFP was dissolvable in a liquid solvent acetone and 50% of nano particles of an inorganic solid-state electrolyte (LGPS prepared in Example 3) were added into the resulting polymer solution to form a slurry. The slurry was coated onto a glass surface with acetone subsequently removed to form polymer/LGPS payers. An IEC-preloaded anode was prepared by coating a layer of ion-conducting elastomer on a Cu foil following a procedure described in Example 11 and 15, respectively, provided below. An IEC-preloaded anode, a polymer/LGPS layer, and an IEC-preloaded cathode were laminated and enclosed in a protective casing. The anionic polymerization of cyclic ester of phosphoric acid residing in the pores of an anode and those in a cathode was allowed to proceed at room temperature (or lower) overnight to produce a solid state cell.

### Example 11: Anode-Less Lithium Metal Battery Containing a High-Elasticity Polymer (Elastomer) Electrolyte

The ethoxylated trimethylopropane triacrylate monomer (ETPTA, Mw=428, Sigma-Aldrich) was dissolved in a solvent mixture of ethylene carbonate (EC)/diethyl carbonate (DEC), at a weight-based composition ratio of the ETPTA/solvent of 3/97 (w/w). Subsequently, benzoyl peroxide (BPO, 1.0 wt. % relative to the ETPTA content) as a radical initiator, along with a desired amount of selected lithium salt (e.g., lithium hexafluorophosphate, LiPF₆⁻, or lithium borofluoride, LiBF₄), were added to allow for thermal crosslinking reaction upon deposition on a Cu foil surface. This layer of ETPTA monomer/initiator was then thermally cured at 60° C. for 30 min to obtain an elastomer-coated Cu foil as an anode.

On a separate basis, some amount of the ETPTA monomer/solvent/initiator solution was cast onto a glass surface to form a wet film, which was thermally dried and then cured at 60° C. for 30 min to form a film of cross-linked polymer. In this experiment, the BPO/ETPTA weight ratio was varied from 0.1% to 4% to vary the degree of cross-linking in several different polymer films. Some of the cured polymer samples were subjected to dynamic mechanical testing to obtain the equilibrium dynamic modulus, Ge, for the determination of the number average molecular weight between two cross-link points (Mc) and the corresponding number of repeat units (Nc), as a means of characterizing the degree of cross-linking. The typical and preferred number of repeat units (Nc) is from 5 to 5,000, more preferably from 10 to 1,000, further preferably from 20 to 500, and most preferably from 50 to 500.

Several tensile testing specimens were cut from each cross-link film and tested with a universal testing machine. The testing results indicate that BPO-initiated cross-linked ETPTA polymers have an elastic deformation from approximately 230% to 700%. The above values are for neat polymers without any additive. The addition of up to 30% by weight of an inorganic filler typically reduces this elasticity down to a reversible tensile strain in the range of 10% to 120%.

The high-elasticity cross-linked ETPTA polymer electrolyte layer appears to be capable of reversibly deforming to a great extent without breakage when the lithium foil decreases in thickness during battery discharge. The polymer layer also enables a significantly more uniform deposition of lithium ions upon returning from the cathode during a battery re-charge; hence, no lithium dendrite. These were observed by using SEM to examine the surfaces of the electrodes recovered from the battery cells after some numbers of charge-discharge cycles.

### Example 12: High-Elasticity Polymer Layer Implemented as a First Solid Electrolyte Coated on a Cu Foil in an Anodeless Lithium-LiCoO₂ Cell (the Cell being Initially Lithium-Free)

The high-elasticity polymer for making an elastic polymer separator was based on cationic polymerization and cross-linking of the cyanoethyl polyvinyl alcohol (PVA-CN) in succinonitrile (SN). The procedure began with dissolving PVA-CN in succinonitrile to form a mixture solution. This step was followed by adding an initiator into the solution. For the purpose of incorporating some lithium species into the elastomer, we chose to use LiPF₆ as an initiator. The ratio between LiPF₆ and the PVA-CN/SN mixture solution was varied from 1/20 to 1/2 by weight to form a series of precursor solutions. Subsequently, these solutions were separately spray-deposited to form a thin layer of precursor reactive mass onto a Cu foil. The precursor reactive mass was then heated at a temperature from 80° C. for 2 hours to obtain a layer of partially cured high-elasticity polymer adhered to the Cu foil surface to form a semi-active anode.

A NCM-811 based cathode active layer was immersed in precursor reactive solution for 1 hour, allowing the reactive solution to permeate into pores of the cathode active layer, leaving some reactive precursor solution on the surface. This NCM-811 based cathode layer supported by an Al foil was then brought to cover the semi-active anode to form a reactive cell in a casing, which was subjected to a curing treatment at 100° C. for 5 hours to obtain an anodeless lithium metal cell. Electrochemical testing results show that the cell having an elastomer solid electrolyte and an interface enhancer composition offers a significantly more stable cycling behavior.

Additionally, some amount of the reacting mass, PVA-CN/LiPF₆⁻, was cast onto a glass surface to form several films which were polymerized and cross-linked to obtain cross-linked polymers having different degrees of cross-linking. Tensile testing was also conducted on these films and this series of cross-linked polymers can be elastically stretched up to approximately 80%.

### Example 13: Li Metal Cells Containing a PETEA-Based Elastomer-Protected Anode and an IEC Enhanced Cathode

For preparing as an elastic composite separator layer, pentaerythritol tetra-acrylate (PETEA), Formula 3, was used as a monomer:

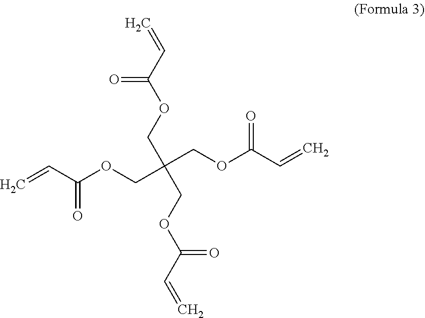 [SMILES: C=CC(=O)OCC(COC(=O)C=C)(COC(=O)C=C)COC(=O)C=C]

In a representative procedure, the precursor solution was composed of 1.5 wt. % PETEA (C₁₇H₂₀O₈) monomer and 0.1 wt. % azodiisobutyronitrile (AIBN, C₈H₁₂N₄) initiator dissolved in a solvent mixture of 1,2-dioxolane (DOL)/dimethoxymethane (DME) (1:1 by volume). The PETEA/AIBN precursor solution, along with a lithium salt (such as lithium borofluoride and LiF) dispersed therein, was cast onto a lithium metal layer pre-deposited on a Cu foil surface to form a precursor film, which was polymerized and cured at 70° C. for half an hour to obtain a lightly cross-linked polymer. This polymer layer was then covered with an IEC-impregnated PVDF electrolyte-coated cathode electrode (prepared in Example 7).

Additionally, the reacting mass, PETEA/AIBN (without any additive), was cast onto a glass surface to form several films that were polymerized and cured to obtain cross-linked polymers having different degrees of cross-linking. Tensile testing was also conducted on these films and this series of cross-linked polymers can be elastically stretched up to approximately 25% (higher degree of cross-linking) to 80% (lower degree of cross-linking).

### Example 14: Interface Enhancer Composition-Enhanced Li Metal Cells Containing a Sulfonated Triblock Copolymer, Poly(Styrene-Isobutylene-Styrene) or SIBS, as an Elastomer Solid Electrolyte

Both non-sulfonated and sulfonated elastomer composites were used to build an elastic polymer-based solid state electrolyte in the anode-less lithium cells. The sulfonated versions provide a much higher lithium ion conductivity and, hence, enable higher-rate capability or higher power density. The elastomer matrix can contain a lithium ion-conducting additive, if so desired.

An example of the sulfonation procedure used in this study for making a sulfonated elastomer is summarized as follows: a 10% (w/v) solution of SIBS (50 g) in methylene chloride (500 ml) was prepared. The solution was stirred and refluxed at approximately 40° C., while a specified amount of acetyl sulfate in methylene chloride was slowly added to begin the sulfonation reaction. Acetyl sulfate in methylene chloride was prepared prior to this reaction by cooling 150 ml of methylene chloride in an ice bath for approximately 10 min. A specified amount of acetic anhydride and sulfuric acid was then added to the chilled methylene chloride under stirring conditions. Sulfuric acid was added approximately 10 min after the addition of acetic anhydride with acetic anhydride in excess of a 1:1 mole ratio. This solution was then allowed to return to room temperature before addition to the reaction vessel.

After approximately 5 h, the reaction was terminated by slowly adding 100 ml of methanol. The reacted polymer solution was then precipitated with deionized water. The precipitate was washed several times with water and methanol, separately, and then dried in a vacuum oven at 50° C. for 24 h. This washing and drying procedure was repeated until the pH of the wash water was neutral. After this process, the final polymer yield was approximately 98% on average. This sulfonation procedure was repeated with different amounts of acetyl sulfate to produce several sulfonated polymers with various levels of sulfonation or ion-exchange capacities. The mol % sulfonation is defined as: mol %=(moles of sulfonic acid/moles of styrene)×100%, and the ion-exchange capacity is defined as the mille-equivalents of sulfonic acid per gram of polymer (mequiv./g).

After sulfonation and washing of each polymer, the S-SIBS samples were dissolved in a mixed solvent of toluene/hexanol (85/15, w/w) with concentrations ranging from 0.5 to 2.5% (w/v). The solution samples were spray-coated on a Cu foil to form a sulfonated elastomer-coated Cu foil as an anode. This anode was used to substitute the solid state LLZO-containing electrolyte-coated Cu foil as in Example 8 to form an anodeless lithium metal cell.

### Example 15: Elastic Polyurethane Elastomer as a 1st Solid Electrolyte Layer in an Interface Enhancer Composition-Enhanced Cell

Twenty-four parts by weight of diphenylmethane diisocyanate and 22 parts by weight of butylene glycol were continuously reacted with 100 parts by weight of polyethylene adipate having hydroxyl groups at both terminals (molecular weight of 2.100) with agitation at a reaction temperature of 115° C. (along with approximately 32% by weight of LiF and LiTFSI) for a reaction time of 60 minutes to give a prepolymer having hydroxyl-terminal. This prepolymer having hydroxyl-terminal had a viscosity of 4,000 cP at 70° C.

On a separate basis, 84 parts by weight of diphenylmethane diisocyanate was continuously reacted with 200 parts by weight of polyethylene adipate having hydroxyl groups at both terminals (molecular weight of 2,100) with agitation at a reaction temperature of 115° C. for a reaction time of 60 minutes to give a prepolymer having isocyanate-terminal. This prepolymer having isocyanate-terminal had a viscosity of 1,500 cP at 70° C.

One hundred forty six (146) parts by weight of the thus obtained prepolymer having hydroxyl-terminal and 284 parts by weight of the obtained prepolymer having isocyanate-terminal were continuously injected into a heat exchange reactor and mixed and stirred at a reaction temperature of 190° C. for a residence time of 5-30 minutes. The obtained viscous product was immediately cast onto a Cu foil surface to obtain a layer of elastic polymer having a thickness of approximately 4.1, 12.2, and 20 μm, respectively. The elastomer-based solid electrolyte layer was used to replace the 1st solid state electrolyte layer of the lithium metal cell discussed in Example 10.

On a separate basis, a sample of reactive polysiloxane (mixed with 5% by wt. of LiF and 5% Li₂CO₃) was cast onto an anode surface and cured at 115° C. for 2 hours to form an elastic polymer film of 8-45 μm in thickness. The lithium ion conductivity of these thin films was approximately 4.5-9.5 10⁻⁵ S/cm.

### Example 16: First Solid-State Electrolyte Layer Featuring Poly(Butyl Acrylate) or PBA Rubber Containing Dinitrile/LiTFSI-Based Plastic Crystals Dispersed Therein

For polymerization of PBA rubber, azobisisobutyronitrile (AIBN; 0.5 mol %) and poly(ethylene glycol) diacrylate (PEGDA; 1 mol %) were used as the thermal initiator and cross-linking agent, respectively. In this butyl acrylate (BA) polymerization process, BA/PEGDA produces polymers chemically cross-linked by PEGDA, eventually resulting in elastomer networks. Dinitrile (AND, GLN, and SEN, respectively), in combination with a lithium salt (e.g., LiTFSI), were used to form plastic crystal domains, where the chemical structures of these dinitriles are given below:

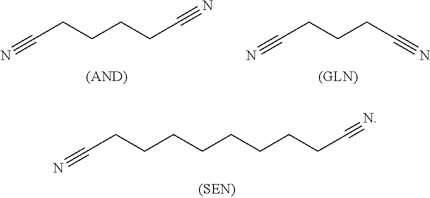 [SMILES: N#CCCCCC#N ; N#CCCCC#N ; N#CCCCCCCCCC#N]

The BA-based solutions were prepared by dissolving 1 mol % PEGDA, 0.5 mol % AIBN, and 1 M LiTFSI powder in BA liquid. The BA-based solutions were polymerized at 70° C. for 2 h to obtain BA-based elastomer with plastic crystal domains dispersed therein. The dinitrile-based solutions were made by mixing a dinitrile with 1 M LiTFSI powder and 5 vol % fluoroethylene carbonate additive at 60° C. to protect against the potential side reaction of dinitrile with Li metal. The two prepared liquid solutions were homogeneously mixed in a volume ratio of 1:1 at 50° C. to produce the elastomer. After dispensing and depositing the prepared solution onto a surface of an anode current collector (Cu foil), the reactive mass was heated at 70° C. for 2 h to obtain the elastomer layer that is substantially well-bonded to the Cu foil. The corresponding cathode active layer with a preloaded IEC was prepared via a procedure described in Example 9. The anodeless lithium metal cell was prepared in a similar manner.

1. A rechargeable lithium metal battery cell comprising (i) an anode including an anode current collector, but initially no lithium metal or lithium metal alloy deposited on the anode current collector when the battery is made; (ii) a first solid state electrolyte layer deposited on the anode current collector; (iii) a cathode including a cathode current collector and a cathode active layer deposited on the cathode current collector; (iv) a second solid state electrolyte layer, the same as or different than the first electrolyte in chemical composition, disposed on the cathode active layer; and (v) an interface enhancer composition in ionic communication with the anode and the cathode, wherein the interface enhancer composition includes a material selected from (i) a liquid solution including an organic solvent or ionic liquid, and a lithium salt dissolved or dispersed therein, (ii) a polymer containing a lithium salt dissolved or dispersed therein, or (iii) a combination thereof; wherein the battery has at least one of the following features:
a) the first solid state electrolyte layer is in physical contact with the second solid state electrolyte layer and the two solid state electrolyte layers, in combination, have a total thickness from 10 nm to 100 μm and are disposed between the anode and the cathode;
b) at least one of the two solid state electrolyte layers includes a solid polymer electrolyte, a polymer gel electrolyte, an inorganic solid-state electrolyte, or a polymer/inorganic composite electrolyte, wherein at least one of the first and the second solid state electrolyte layer has a lithium-ion conductivity no less than 10⁻⁶ S/cm;
c) at least one of the two solid state electrolyte layers includes a solid polymer electrolyte or a polymer gel electrolyte including an elastomer having a thickness from 50 nm to 100 μm and a lithium ion conductivity from 10⁻⁶ S/cm to 5×10⁻² S/cm at room temperature and a fully recoverable tensile strain from 2% to 1,000% when measured without any additive dispersed therein; and
d) the cathode active layer includes particles of a Li-containing cathode active material, from 0.1% to 10% by weight of a conductive additive, and pores occupying 1% to 40% by volume of the cathode active layer, wherein the interface enhancer composition resides in 30% to 100% of the pores.

2. The rechargeable lithium battery cell of claim 1, wherein the battery cell is a cylindrical cell, a pouch cell, or a prismatic cell.

3. The rechargeable lithium battery cell of claim 1, wherein the interface enhancer composition, the cathode active layer, the first solid state electrolyte, or the second solid state electrolyte further includes a flame retardant additive dispersed or dissolved therein.

4. The rechargeable lithium battery cell of claim 3, wherein the flame retardant additive is selected from a halogenated flame retardant, phosphorus-based flame retardant, melamine flame retardant, metal hydroxide flame retardant, silicon-based flame retardant, phosphate flame retardant, biomolecular flame retardant, or a combination thereof.

5. The rechargeable lithium battery cell of claim 1, wherein the interface enhancer composition forms a contiguous phase or a continuous lithium ion pathway from the cathode active material through the first and the second solid-state electrolyte layers to the anode and the interface enhancer composition is in physical contact with substantially all particles of the cathode active material.

6. The rechargeable lithium battery cell of claim 1, wherein the interface enhancer composition includes (i) a lithium salt or (ii) a liquid solution including an ionic liquid or an organic solvent and a lithium salt dissolved or dispersed in the ionic liquid or organic solvent, and wherein the interface enhancer composition forms a contiguous phase or a continuous lithium ion pathway from the cathode active material through the solid state electrolyte layers to the anode.

7. The rechargeable lithium battery cell of claim 1, wherein the ionic liquid in the interface enhancer composition is selected from a room temperature ionic liquid having a cation selected from tetraalkylammonium, di-, tri-, or tetra-alkylimidazolium, alkylpyridinium, dialkyl-pyrrolidinium, dialkylpiperidinium, tetraalkylphosphonium, trialkylsulfonium, 1-butyl-3-methylimidazolium hexafluorophosphate (bmimPF₆), 1-butyl-3-methylimidazolium acetate (bmimACET), 1-butyl-3-methylimidazolium thiocyanate (bmimSCN), EMITFSI, [Cₙmim][TFSI] or [Cₙmim][FSI] (n=2, 4), 1-ethyl-3-methylimidazolium bis(fluorosulfonyl)imide ([C2mim][FSI]), N-methyl-N-propylpyrrolidinium bis(fluorosulfonyl)imide ([Pry13][FSI]), 1-Ethyl-3-methylimidazolium bis(trifluoromethylsulfonyl)imide ([EMIM][TFSI]), 1-Ethyl-3-methylimidazolium trifluoromethanesulfonate ([EMIM][Tf]) and 1-Butyl-3-methylimidazolium dicyanamide ([BMIM][DCA]), or a combination thereof.

8. The rechargeable lithium battery cell of claim 1, wherein the ionic liquid in the interface enhancer composition is selected from a room temperature ionic liquid having an anion selected from BF₄⁻, B(CN)₄⁻, CH₃BF₃⁻, CH₂CHBF₃⁻, CF₃BF₃⁻, C₂F₅BF₃⁻, n-C₃F₇BF₃⁻, n-C₄F₉BF₃⁻, PF₆⁻, CF₃CO₂⁻, CF₃SO₃⁻, N(SO₂CF₃)₂⁻, N(COCF₃)(SO₂CF₃)⁻, N(SO₂F)₂⁻, N(CN)₂⁻, C(CN)₃⁻, SCN⁻, SeCN⁻, CuCl₂⁻, AlCl₄⁻, F(HF)_{2.3}⁻, a thiocyanate anion, or a combination thereof.

9. The rechargeable lithium battery cell of claim 1, wherein the organic solvent in the interface enhancer composition is selected from a fluorinated carbonate, hydrofluoroether, fluorinated ester, fluorinated vinyl carbonate, fluorinated ether, fluorinated vinyl ester, and fluorinated vinyl ether, sulfone, nitrile, phosphate, phosphite, alkyl phosphonate, phosphazene, sulfate, siloxane, silane, 1,3-dioxolane (DOL), 1,2-dimethoxyethane (DME), tetraethylene glycol dimethylether (TEGDME), poly(ethylene glycol) dimethyl ether (PEGDME), diethylene glycol dibutyl ether (DEGDBE), 2-ethoxyethyl ether (EEE), sulfone, sulfolane, ethylene carbonate (EC), dimethyl carbonate (DMC), methylethyl carbonate (MEC), diethyl carbonate (DEC), ethyl propionate, methyl propionate, propylene carbonate (PC), Gamma-butyrolactone (Y-BL), acetonitrile (AN), ethyl acetate (EA), propyl formate (PF), methyl formate (MF), toluene, xylene, methyl acetate (MA), fluoroethylene carbonate (FEC), vinylene carbonate (VC), allyl ethyl carbonate (AEC), a fluorinated solvent, a sulfone, a sulfide, a nitrile, a phosphate, a phosphite, a phosphonate, a phosphazene, a sulfate, a siloxane, Glyme, a chemical derivative thereof, or a combination thereof.

10. The rechargeable lithium battery cell of claim 9, wherein the sulfone or sulfide is selected from vinyl sulfone, allyl sulfone, alkyl vinyl sulfone, aryl vinyl sulfone, vinyl sulfide, a vinyl-containing variant of TrMS, MTrMS, TMS, EMS, MMES, EMES, EMEES, or a combination thereof:

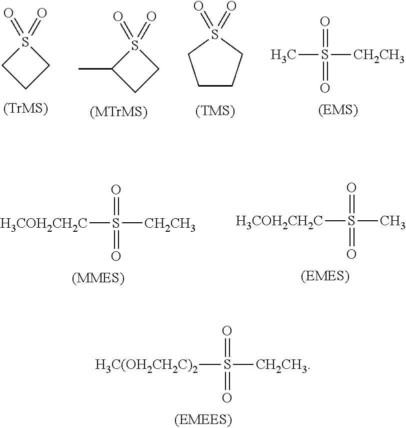

11. The rechargeable lithium battery cell of claim 9, wherein the vinyl sulfone or sulfide is selected from ethyl vinyl sulfide, allyl methyl sulfide, phenyl vinyl sulfide, phenyl vinyl sulfoxide, allyl phenyl sulfone, allyl methyl sulfone, divinyl sulfone, or a combination thereof, wherein the vinyl sulfone does not include methyl ethylene sulfone and ethyl vinyl sulfone.

12. The rechargeable lithium battery of claim 9, wherein the nitrile includes a dinitrile or is selected from AND, GLN, SEN, SN, or a combination thereof:

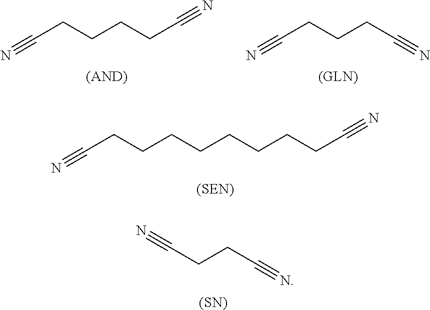

13. The rechargeable lithium battery cell of claim 9, wherein the phosphate is selected from allyl-type, vinyl-type, styrenic-type and (meth)acrylic-type monomers bearing a phosphonate moiety.

14. The rechargeable lithium battery cell of claim 9, wherein the phosphate, phosphonate, phosphonic acid, phosphazene, or phosphite is selected from TMP, TEP, TFP, TDP, DPOF, DMMP, DMMEMP, tris(trimethylsilyl) phosphite (TTSPi), alkyl phosphate, triallyl phosphate (TAP), a combination thereof, wherein TMP, TEP, TFP, TDP, DPOF, DMMP, DMMEMP, and phosphazene have the following chemical formulae: 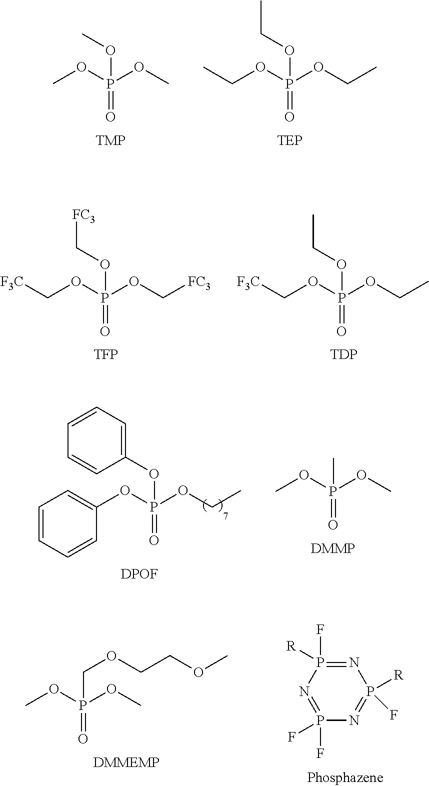
wherein R═H, NH₂, or C₁-C₆ alkyl.

15. The rechargeable lithium battery cell of claim 9, wherein the siloxane or silane is selected from alkylsiloxane (Si—O), alkyylsilane (Si—C), liquid oligomeric silaxane (—Si—O—Si—), or a combination thereof.

16. The rechargeable lithium battery cell of claim 1, wherein the inorganic solid-state electrolyte or the polymer/inorganic composite electrolyte includes an inorganic solid electrolyte material selected from an oxide type, sulfide type, hydride type, halide type, halogen-modified sulfide type, borate type, phosphate type, lithium phosphorus oxynitride (LiPON), garnet-type, lithium superionic conductor (LISICON) type, sodium superionic conductor (NASICON) type, or a combination thereof.

17. The rechargeable lithium battery cell of claim 1, wherein the polymer/inorganic composite electrolyte includes particles of inorganic material selected from SiO₂, TiO₂, Al₂O₃, MgO₂, ZnO₂, ZnO₂, CuO, CdO, Li₂CO₃, Li₂O, Li₂C₂O₄, LiOH, LIX, ROCO₂Li, HCOLi, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

18. The rechargeable lithium battery cell of claim 1, wherein the first or second solid-state electrolyte includes a polymer selected from poly(ethylene oxide), polypropylene oxide, polyoxymethylene, polyvinylene carbonate, polypropylene carbonate, poly(ethylene glycol), poly(acrylonitrile), poly(methyl methacrylate), poly(vinylidene fluoride), poly bis-methoxy ethoxyethoxide-phosphazenex, polyvinyl chloride, polydimethylsiloxane, poly(vinylidene fluoride)-hexafluoropropylene, cyanoethyl poly(vinyl alcohol), a pentaerythritol tetra-acrylate-based polymer, an aliphatic polycarbonate, a single Li-ion conducting solid polymer (e.g., those with a carboxylate anion, a sulfonylimide anion, or sulfonate anion), poly(ethylene glycol) diacrylate, poly(ethylene glycol) methyl ether acrylate, polyurethane, polyurethan-urea, polyacrylamide, a polyionic liquid, polymerized 1,3-dioxolane, polyepoxide ether, polysiloxane, poly(acrylonitrile-butadiene), polynorbornene, poly(hydroxyl styrene), poly(ether ether ketone), polypeptoid, poly(ethylene-maleic anhydride), polycaprolactone, poly(trimethylene carbonate), an acrylic polymer, a butyl acrylate rubber, polyphosphate, polyphosphite, polyphosphonate, polyphosphazenes, polytetrahydrofuran, a copolymer thereof, a semi-penetrating network thereof, a sulfonated derivative thereof, or a combination thereof.

19. The rechargeable lithium battery cell of claim 1, wherein the first or second solid-state electrolyte includes an elastomer selected from natural polyisoprene, synthetic polyisoprene, polybutadiene, chloroprene rubber, polychloroprene, butyl rubber, poly(butyl diacrylate), styrene-butadiene rubber, nitrile rubber, ethylene propylene rubber, ethylene propylene diene rubber, metallocene-based poly(ethylene-co-octene) elastomer, poly(ethylene-co-butene) elastomer, styrene-ethylene-butadiene-styrene elastomer, epichlorohydrin rubber, polyacrylic rubber, silicone rubber, fluorosilicone rubber, perfluoroelastomers, polyether block amides, chlorosulfonated polyethylene, ethylene-vinyl acetate, thermoplastic elastomer, protein resilin, protein elastin, ethylene oxide-epichlorohydrin copolymer, polysiloxane, poly(alkyl siloxane), polyurethane, urethane-urea copolymer, urethane-acrylic copolymer, a copolymer thereof, a sulfonated version thereof, or a combination thereof.

20. The rechargeable lithium battery cell of claim 19, wherein the elastomer contains a lightly cross-linked network of polymer chains having an ether linkage, nitrile-derived linkage, benzo peroxide-derived linkage, ethylene oxide or ethylene glycol linkage, propylene oxide linkage, vinyl alcohol linkage, cyano-resin linkage, triacrylate monomer-derived linkage, tetraacrylate monomer-derived linkage, a derivative thereof, or a combination thereof, in the cross-linked network of polymer chains having a degree of crosslinking that affords an elasticity of the polymer in the range from 5% to 1,000%.

21. The rechargeable lithium battery cell of claim 19, wherein said elastomer further includes from 0.1% to 70% by weight of a lithium ion-conducting material dispersed or dissolved in the high-elasticity polymer.

22. The rechargeable lithium battery cell of claim 21, wherein said lithium ion-conducting material includes a lithium salt selected from lithium perchlorate, LiClO₄, lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid-based lithium salt, Li₂CO₃, Li₂O, Li₂C₂O₄, LiOH, LIX, ROCO₂Li, HCOLI, ROLi, (ROCO₂Li)₂, (CH₂OCO₂Li)₂, Li₂S, LiₓSO_{y}, or a combination thereof, wherein X═F, Cl, I, or Br, R=a hydrocarbon group, x=0-1, y=1-4.

23. The rechargeable lithium battery cell of claim 1, wherein the elastomer includes from 5% to 95% by weight of a lithium ion-conducting plastic crystal or organic domain phase dispersed in or connected to the elastomer.

24. The rechargeable lithium battery cell of claim 1, wherein said lithium salt is selected from lithium perchlorate (LiClO₄), lithium hexafluorophosphate (LiPF₆), lithium borofluoride (LiBF₄), lithium hexafluoroarsenide (LiAsF₆), lithium trifluoro-metasulfonate (LiCF₃SO₃), bis-trifluoromethyl sulfonylimide lithium (LiN(CF₃SO₂)₂), lithium bis(oxalato)borate (LiBOB), lithium oxalyldifluoroborate (LiBF₂C₂O₄), lithium oxalyldifluoroborate (LiBF₂C₂O₄), lithium nitrate (LiNO₃), Li-Fluoroalkyl-Phosphates (LiPF₃(CF₂CF₃)₃), lithium bisperfluoro-ethysulfonylimide (LiBETI), lithium bis(trifluoromethanesulphonyl)imide, lithium bis(fluorosulphonyl)imide, lithium trifluoromethanesulfonimide (LiTFSI), an ionic liquid lithium salt, or a combination thereof.

25. The rechargeable lithium battery cell of claim 4, wherein said flame retardant additive is in a form of encapsulated particles including the additive encapsulated by a shell of a substantially lithium ion-impermeable and liquid electrolyte-impermeable coating material, wherein said shell is breakable when exposed to a temperature higher than a threshold temperature.

26. The rechargeable lithium battery cell of claim 1, wherein said polymer/inorganic composite electrolyte includes an inorganic solid material in a fine powder form having a particle size from 2 nm to 30 μm, wherein said particles of inorganic solid material are dispersed in said polymer or chemically bonded by said polymer.

27. The rechargeable lithium battery cell of claim 1, which is a lithium metal secondary cell, a lithium-sulfur cell, or a lithium-selenium cell.

28. The rechargeable lithium battery cell of claim 1, wherein the cathode includes a cathode active material selected from lithium nickel manganese oxide (LiNiₐMn₂₋ₐO₄, 0<a<2), lithium nickel manganese cobalt oxide (LiNiₙMnₘCo₁₋ₙ₋ₘO₂, 0<n<1, 0<m<1, n+m<1), lithium nickel cobalt aluminum oxide (LiNi_{c}Co_{d}Al_{1-c-d}O₂, 0<c<1, 0<d<1, c+d<1), lithium manganate (LiMn₂O₄), lithium iron phosphate (LiFePO₄), lithium manganese oxide (LiMnO₂), lithium cobalt oxide (LiCoO₂), lithium nickel cobalt oxide (LiNiₚCo₁₋ₚO₂, 0<p<1), lithium nickel manganese oxide (LiNi_{q}Mn_{2-q}O₄, 0<q<2), a lithium sulfide, a lithium selenide, or a combination thereof.

29.-36. (canceled)

37. The rechargeable lithium battery cell of claim 1, wherein the cathode active layer further includes from 0.1% to 20% by weight of the second solid state electrolyte.
